(19) United States
(12) Patent Application Publication
(10) Pub. No.: US 2024/0121879 A1
(43) Pub. Date: Apr. 11, 2024

(54) LITHIUM TARGET WITH INTERMEDIATE LAYER

(71) Applicant: TAE Technologies, Inc., Foothill Ranch, CA (US)

(72) Inventors: Daniel Scott Marshall, Chandler, AZ (US); Anatoly Borsovich Muchnikov, Mission Viejo (CA); Rainer Fasching, Mill Valley, CA (US)

(21) Appl. No.: 18/481,054

(22) Filed: Oct. 4, 2023

Related U.S. Application Data
(60) Provisional application No. 63/413,608, filed on Oct. 5, 2022.
(60) Provisional application No. 63/508,125, filed on Jun. 14, 2023.

(51) Int. Cl. H05H 6/00

(52) U.S. Cl. CPC H05H 6/00

(57) ABSTRACT

The present disclosure provides a neutron generation target containing a neutron generation region, a highly thermoconductive base plate substrate, and an intermediate layer positioned between the neutron generation region and the substrate to facilitate heat transfer and/or avoid deposition of hydrogen in the substrate. One example of the intermediate layer is highly oriented pyrolytic graphite.

### CROSS-REFERENCE TO RELATED APPLICATIONS

This application claims the benefit of the U.S. Provisional Patent Application No. 63/413,608 filed Oct. 5, 2022, and the U.S. Provisional Patent Application No. 63/508,125 filed Jun. 14, 2023, both of which are incorporated herein by reference in their entirety for all purposes.

### TECHNICAL FIELD

The subject matter described herein relates generally to a neutron generation target containing a neutron generation region (containing, e.g., lithium), a base plate substrate (containing, e.g., copper or graphite), and at least one intermediate layer (containing, e.g., highly oriented graphite) positioned between the neutron generation region and the substrate. The at least one intermediate layer can facilitate heat transfer and/or avoid accumulation of hydrogen in the substrate.

### BACKGROUND

Cancer is one of the leading causes of death in contemporary society. The numbers of new cancer cases and deaths is increasing each year. Currently, cancer incidence is nearly 450 cases per 100,000 men and women per year, while cancer mortality is nearly 71 deaths per 100,000 men and women per year. Locally invasive malignant tumors, such as brain cancer, cancers of head and neck, and cutaneous and extracutaneuous melanomas, are of particular concern as the effective means to treat or inhibit growth of those cancers is limited. For example, boron-neutron capture therapy, or BNCT, uses an accelerator-based neutron source to generate short-lived alpha-particles from boron-10 accumulated in the patients' tumor tissues. These alpha-particles selectively kill tumor cells while avoiding any damage to healthy organs and tissues.

### SUMMARY

The present disclosure provides, inter alia, a lithium-containing neutron generation target, useful to produce a beam of neutrons for bombarding a boron-containing compound in a boron-neutron capture therapy (“BNCT”) of cancer. In one example, the disclosure provides a neutron-generation target which includes a highly thermoconductive substrate, a neutron-generating lithium region over the substrate, and an intermediate layer positioned between the substrate and the lithium region. The present disclosure is based, at least in part, on a realization that including the intermediate layer, such as a graphite layer, in the target advantageously allows for efficient transfer of heat generated during production of neutrons from the lithium region to the substrate, where the heat is further removed from the target by a cooling agent. Not only the intermediate layer facilitates efficient heat removal and helps prevent melting of lithium during operation, but also avoids undesirable inter-diffusion of lithium into the material of the substrate and vice versa. This advantageously allows minimizing the amount of lithium needed for manufacturing the target and substantially reduces the cost of the target and the overall operation. Furthermore, and importantly here, the intermediate layer traps residual, non-reacted protons exiting the neutron-generating lithium region thereby sequestering hydrogen and preventing formation of gaseous hydrogen in the substrate and blistering at the interface of the substrate and the lithium. In a case where the intermediate layer is porous, any hydrogen in the intermediate layer may be removed from the target by diffusion through the pores and into the vacuum system containing the target.

Unless otherwise defined, all technical and scientific terms used herein have the same meaning as commonly understood by one of ordinary skill in the art to which the present application belongs. Methods and materials are described herein for use in the present application; other, suitable methods and materials known in the art can also be used. The materials, methods, and examples are illustrative only and not intended to be limiting. All publications, patent applications, patents, database entries, and other references mentioned herein are incorporated by reference in their entirety. In case of conflict, the present specification, including definitions, will control.

Other systems, devices, methods, features, and advantages of the subject matter described herein will be or will become apparent to one with skill in the art upon examination of the following figures and detailed description. It is intended that all such additional systems, methods, features and advantages be included within this description, be within the scope of the subject matter described herein, and be protected by the accompanying claims. In no way should the features of the example embodiments be construed as limiting the appended claims, absent express recitation of those features in the claims.

### DESCRIPTION OF DRAWINGS

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A is a schematic diagram of an example embodiment of a neutron beam system.

FIG. 1B is a schematic diagram of another example embodiment of a neutron beam system.

FIG. 2A is a cross sectional view depicting an example embodiment of a target assembly subsystem 200.

FIG. 2B is a cross sectional view depicting an example of existing neutron generation target.

FIGS. 3A, 3B, and 3C are cross-sectional, front perspective, and rear perspective views, respectively, depicting an example embodiment of a neutron generation target 100.

FIGS. 3D-3F are cross-sectional views depicting example embodiments of a neutron generation target 100 containing a highly thermoconductive intermediate layer.

FIGS. 4A-4C are cross-sectional views depicting example embodiments of a neutron generation target 100 containing a brazing layer, adhesion layer, and passivation region, respectively.

FIG. 4D is a cross-sectional view depicting an example embodiment of a neutron generation target 100 containing a substrate made from highly thermoconductive material.

FIG. 4E is a cross-sectional view depicting an example embodiment of a neutron generation target 100 containing a substrate made from highly oriented graphite.

FIG. 5 is a flow-chart of an example of a process of treating cancer using a neutron-generating target 100.

FIG. 6A is a cross-sectional view depicting another example of a neutron generation target.

FIG. 6B is a cross-sectional view depicting yet a further example of a neutron generation target.

FIG. 6C is a cross-sectional view depicting a further example of a neutron generation target.

FIG. 6D is a cross-sectional view depicting yet another example of a neutron generation target.

In the drawings, like reference numbers refer to like elements.

### DETAILED DESCRIPTION

Before the present subject matter is described in detail, it is understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

Neutron generation targets and their embodiments described herein can be implemented in a variety of applications where it is desired to use neutron generation. The targets can be used in both medical and non-medical applications. Suitable examples of non-medical applications include fusion reactors, scientific tools for nuclear physics research (e.g., Faraday cups to catch charged particles in a vacuum), industrial manufacturing processes, beam systems for the alteration of material properties (e.g., surface treatment and transmutation), beam systems for the irradiation of food, and non-medical imaging applications (e.g., cargo or container inspection). Suitable examples of medical applications include beam systems for pathogen destruction and medical sterilization, medical diagnostic systems, medical imaging systems, and radiation therapy systems (e.g., X-ray machines, Cobalt-60 machines, linear accelerators, proton beam machines, and neutron beam machines). One example of a medical application of the neutron generation targets described herein is boron neutron capture therapy (“BNCT”).

Generally, boron neutron capture therapy (“BNCT”) is a type of treatment of a variety of types of cancer, including the most difficult types. Suitable examples of such cancers include liver cancer (including liver metastases), oral cancer, colon cancer, brain cancer such as glioblastoma, head and neck cancer, lung cancer, extensive squamous cell carcinoma, laryngeal cancer, and melanoma. BNCT is a technique that selectively aims to treat tumor cells while sparing the normal cells using a chemical compound containing non-radioactive isotope boron-10, which has a high propensity to capture low energy “thermal” or “epithermal” neutrons. In this technique, a boron-containing compound is administered to a patient (e.g., by injecting a parenteral composition to a blood vessel of the patient), allowing boron-10 to selectively collect in tumor cells. Suitable examples of boron delivery agents that can be administered to the cancer patients include boronated amino acids, boron nitride nanotubes, liposome and immunoliposomes carrying particles of boron, various boron-containing nanoparticles, boronated cyclic or acyclic peptides having affinity to cancer cells (e.g., boronated arginylglycylaspartic acid, “RGD,” or a cyclic version thereof), boronated compounds having affinity to receptors overexpressed in cancer cells, boronated sugars, and boronic acid. Generally, these compounds are capable of selectively accumulating within malignant tumors while avoiding healthy tissues (e.g., at least about 85 wt. %, at least about 90 wt. %, at least about 95 wt. %, or at least about 99 wt. % of the boron compound accumulates in the tumor tissue as opposed to the healthy tissues). As used herein, the term “about” means “approximately” (e.g., plus or minus approximately 10% of the indicated value). In case a measurable numerical value is provided in this disclosure, the numerical value encompasses exactly the value and within 10% of the value. For example, upon administration of the boron carrier compound, tumor concentration of boron can be obtained in the range of about 20-50 μg ¹⁰B/g tumor. The tumor concentration of boron can be determined by any means generally known to physicians for this purpose, such as imaging, calibration, and/or biopsy. Once a sufficient amount of boron-10 has collected within the tumor, the patient receives radiation in the form of a neutron beam at or near the tumor site.

Typically, to produce a neutron beam, a neutron generating material, such as lithium, is bombarded with protons of sufficient energy (e.g., energy above the Li⁷→Be⁷ reaction threshold of 1.88 MeV), whereby the protons are generated in an ion accelerator from a beam of negative hydrogen ions. The neutron-generating reaction may be described as follows, where p represents a proton and n represents a neutron:

Li⁷(3p,4n)+p=Be⁷(4p,3n)+n (eq. 1)

The resulting neutron beam is moderated and focused on the patient, where the neutrons react with the boron-10 in the tumor cells to generate a short-range alpha particle (He⁴) that selectively kills the tumor cells:

B¹⁰(5p,5n)+n=Li⁷(3p,4n)+He⁴(2p,2n) (eq. 2)

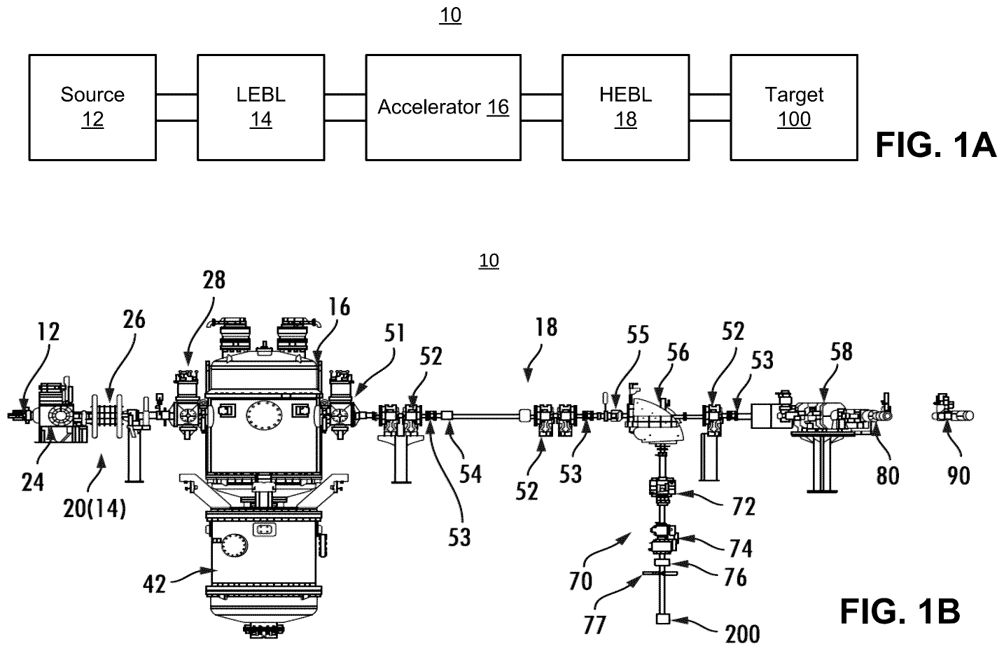

FIG. 1A contains a schematic diagram of an example of a neutron beam system 10, which can be used to generate the neutrons for BNCT using a neutron generation target of the instant disclosure (target 100).

In FIG. 1A, beam system 10 includes a source of ions 12, a low-energy beamline (“LEBL”) 14, an accelerator 16 coupled to the LEBL 14, and a high-energy beamline (“HEBL”) 16 extending from the accelerator 16 to a target 100. LEBL 14 is configured to transport a charged particle beam, e.g., negative hydrogen ions, from the ion source 12 to an input of accelerator 16, which in turn is configured to produce a beam of protons by accelerating the beam of hydrogen ions transported by LEBL 14. HEBL 18 transfers the proton beam from an output of accelerator 16 to target 100. Upon bombardment by protons of sufficient energy, target 100 is configured to produce a beam of neutrons that is further directed to the tumor site in the patient body (not shown).

FIG. 1B is a schematic diagram illustrating another example embodiment of a neutron beam system 10 for use in boron neutron capture therapy (BNCT). Here, source 12 is an ion source and accelerator 16 is a tandem accelerator. Neutron beam system 10 includes a pre-accelerator system 20, serving as a charged particle beam injector, high voltage (HV) tandem accelerator 16 coupled to pre-accelerator system 20, and HEBL 18 extending from tandem accelerator 16 to a neutron target assembly 200 housing target 100 (not shown). Pre-accelerator system 20 is configured to transport the hydrogen ion beam from ion source 12 to the input (e.g., an input aperture) of tandem accelerator 16, and thus also acts as LEBL 14. Tandem accelerator 16, which is powered by a high voltage power supply 42 coupled thereto, can produce a proton beam with an energy generally equal to twice the voltage applied to the accelerating electrodes positioned within accelerator 16. The energy level of the proton beam can be achieved by accelerating the beam of negative hydrogen ions from the input of accelerator 16 to the innermost high-potential electrode, stripping two electrons from each ion, and then accelerating the resulting protons downstream by the same applied voltage.

HEBL 18 can transfer the proton beam from the output of accelerator 16 to the target 100 within the neutron target assembly 200 positioned at the end of a branch 70 of the beamline extending into a patient treatment room. System 10 can be configured to direct the proton beam to any number of one or more targets and associated treatment areas. In this embodiment, the HEBL 18 includes three branches 70, 80 and 90 that can extend into three different patient treatment rooms, where each branch can terminate in a target assembly 200 and downstream beam shaping apparatus (not shown). HEBL 18 can include a pump chamber 51, quadrupole magnets 52 and 72 to prevent de-focusing of the beam, dipole or bending magnets 56 and 58 to steer the beam into treatment rooms, beam correctors 53, diagnostics such as current monitors 54 and 76, a fast beam position monitor 55 section, and a scanning magnet 74.

The design of HEBL 18 depends on the configuration of the treatment facility (e.g., a single-story configuration of a treatment facility, a two-story configuration of a treatment facility, and the like). The proton beam can be delivered to target assembly 200 (e.g., positioned near a treatment room) with the use of bending magnet 56. Quadrupole magnets 72 can be included to then focus the proton beam to a certain size at the target. Then, the proton beam passes one or more scanning magnets 74, which provides lateral movement of the proton beam onto the target surface in a desired pattern (e.g., spiral, curved, stepped in rows and columns, combinations thereof, and others). The proton beam lateral movement can help achieve smooth and even time-averaged distribution of the proton beam on the lithium target 100, preventing overheating and making the neutron generation as uniform as possible within the lithium layer.

After entering scanning magnets 74, the proton beam can be delivered into a current monitor 76, which measures beam current. Target assembly 200 can be physically separated from the HEBL volume with a gate valve 77. The main function of the gate valve is separation of the vacuum volume of the beamline from the target while loading the target and/or exchanging a used target for a new one. In embodiments, the beam may not be bent by 90 degrees by a bending magnet 56, it rather goes straight to the right of FIG. 1B, then enters quadrupole magnets 52, which are located in the horizontal beamline. The beam could be subsequently bent by another bending magnet 58 to a needed angle, depending on the building and room configuration. Otherwise, bending magnet 58 could be replaced with a Y-shaped magnet in order to split the beamline into two directions for two different treatment rooms located on the same floor.

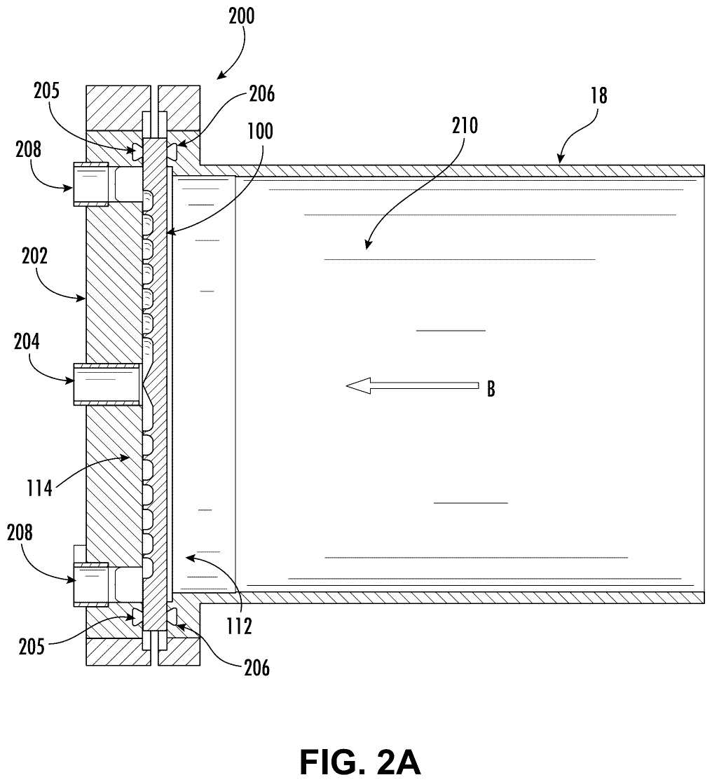

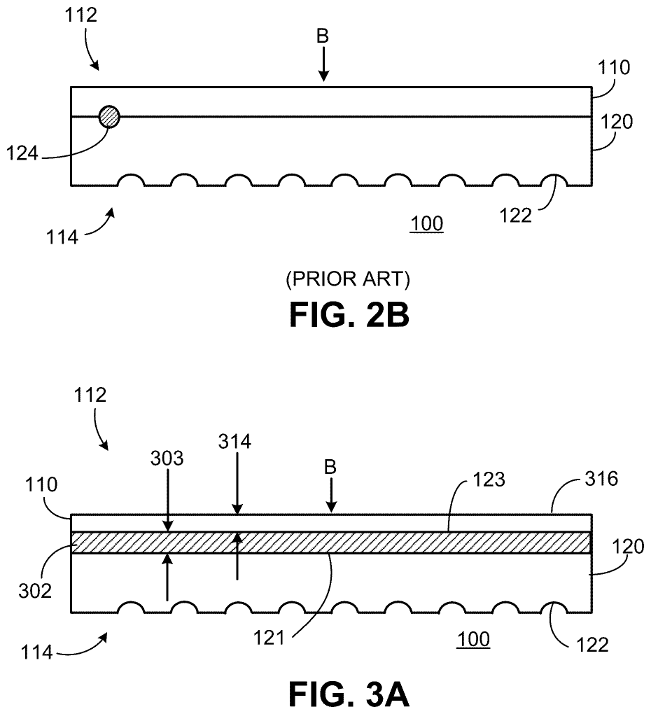

FIG. 2A is a cross-sectional view drawing depicting an example embodiment of a target assembly subsystem 200 of the neutron beam system 10 shown in FIG. 1B. In this embodiment, neutron generation target 100 is enclosed between a cap 202 and a vacuum or near vacuum interior region 210 of HEBL 18. An arrow B shows the direction of the charged particle beam that first impacts the face of upstream side 112. Cooling of target 100 can be accomplished on the opposite downstream side 114 (from which the neutron beam exits target 100). Cap 202 can be bolted to HEBL 18, thus providing both a vacuum tight seal 206 between target 100 and vacuum region 210 of HEBL 18, and a water-tight seal 205 between target 100 and coolant inlet 204 and outlets 208.

In one general aspect, the present disclosure provides a target useful in applications where various forms of radiation (e.g., neutron radiation) are required. One example of the target of this disclosure is a neutron-generating target, such as target 100 within the target assembly 200 (with reference to FIGS. 1B and 2A), useful to produce a beam of neutrons for bombarding a boron-containing compound administered to a patient during BNCT.

Some targets 100 were previously used for neutron generation, including for BNCT. An example of such a target is shown in FIG. 2B. Generally, the target includes a neutron generation layer 110, which is usually a planar layer consisting mostly of lithium. The layer 110 is bonded to a substrate 120 made from a highly thermoconductive material such as copper. Abeam of protons (e.g., a beam in direction B) bombards the neutron generating layer 110 of target 100 at the upstream side 112. Although shown as being incident in direction B, the proton beam can be incident on the target 100 at any angle. For example, the target 100 can be angled such that the proton beam is incident on the target at an angle between zero degrees and ninety degrees relative to a planar surface of the neutron generating layer 110. The beam of protons bombarding the neutron generating layer 110 at the upstream side 112 and the beam of neutrons exiting the substrate 120 of the target 100 at the downstream side 114 generate a tremendous amount of heat. To remove this heat, the substrate 120 typically contains fluid flow channels such as spiral channels 122, where a coolant (e.g., water) constantly flows during operation to cool the substrate 120. The thickness of lithium layer 110 is usually selected such that most protons either react with the Li atoms within the layer to produce Be (see eq. 1 above) or, if the protons do not possess sufficient energy to initiate the reaction, stop and become trapped within the lithium layer no less than several micrometers from the substrate 120. Over time, however, some protons penetrate through the lithium layer and deposit in the substrate 120, where they accumulate to form bubbles of hydrogen gas 124, which may form blisters just beneath the interface of the lithium layer 110 and the substrate 120 and subsequent exfoliation of a thin layer of substrate 120. Blistering and exfoliation are highly undesirable as these processes present significant obstacles to successful operation of the target. Blisters disrupt the contact between lithium layer 110 and substrate 120 during operation and inhibit efficient heat removal from the substrate 120, which may lead to melting and evaporation of the lithium layer 110, or alloying and diffusion of molten lithium into copper, or exfoliation of the lithium layer 110 in the region near the blister. These processes result in reduced purity or thickness of layer 110 and concomitantly a reduction in the neutron output. Ultimately, hydrogen blisters can lead to a reduction in efficiency of neutron production by the target and interruption of the workflow of the neutron beam system 10. Existing solutions do little to contribute to efficiency and effectiveness of the target operation. One solution includes limiting target lifetime by replacing the target before or at the onset of the blistering process by closely monitoring reduction in the neutron production rate. Another solution includes compensating for the reduced neutron production rate by extending patient exposure times. While the former solution substantially increases the cost of operation, the latter solution may not even achieve the desired treatment outcome because of the decreased amount of boron at the tumor site over the course of the extended exposure due to metabolic clearance of the boron-containing drug from the patient's body.

Accordingly, the present disclosure provides, inter alia, a neutron-generation target that advantageously reduces or avoids accumulation of hydrogen in the substrate and therefore reduces or avoids blistering and associated problems and promotes efficient operation of the neutron beam system 10. In one general aspect, this disclosure provides a target containing (i) a substrate; (ii) a neutron generation region positioned over the substrate; and (iii) an intermediate layer positioned between the substrate and the neutron generation region. The intermediate layer of the target of this disclosure is made of a material or a mixture of materials that help prevent or substantially avoid damage to, blistering of, and exfoliation of the neutron-generating layer (e.g., lithium layer) from the substrate. In one example, the intermediate layer advantageously sequesters or adsorbs hydrogen (e.g., protons used for neutron generation) that penetrates the neutron generation region, thereby avoiding any accumulation of hydrogen in the substrate. At the same time, the material of the intermediate layer is highly thermoconductive to facilitate efficient heat transfer from both the neutron generation region and the intermediate layer to the substrate during operation.

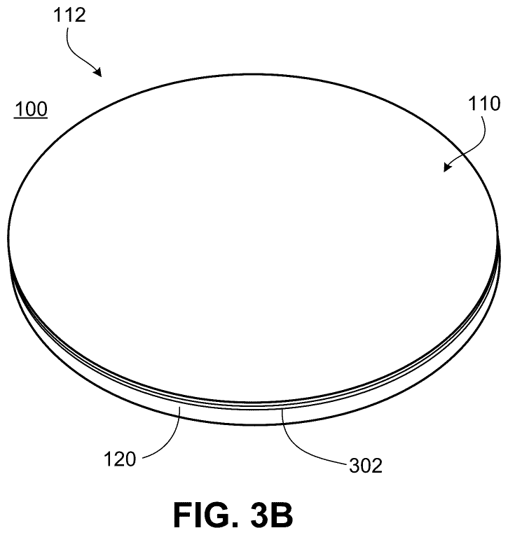

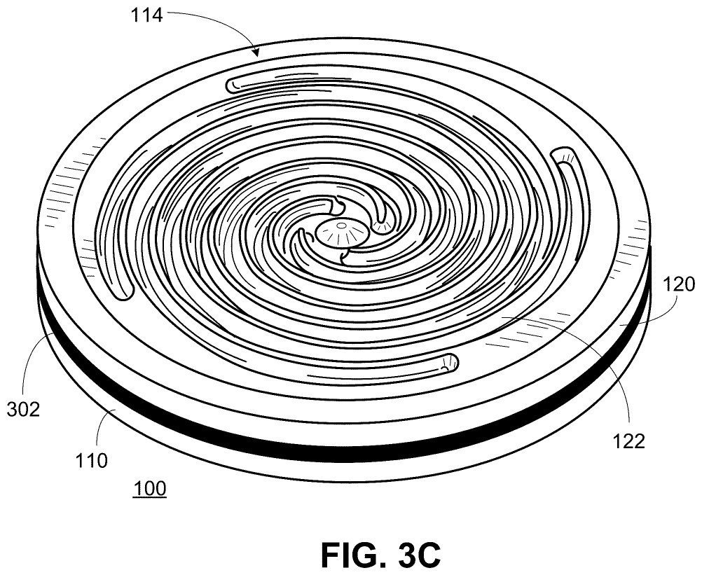

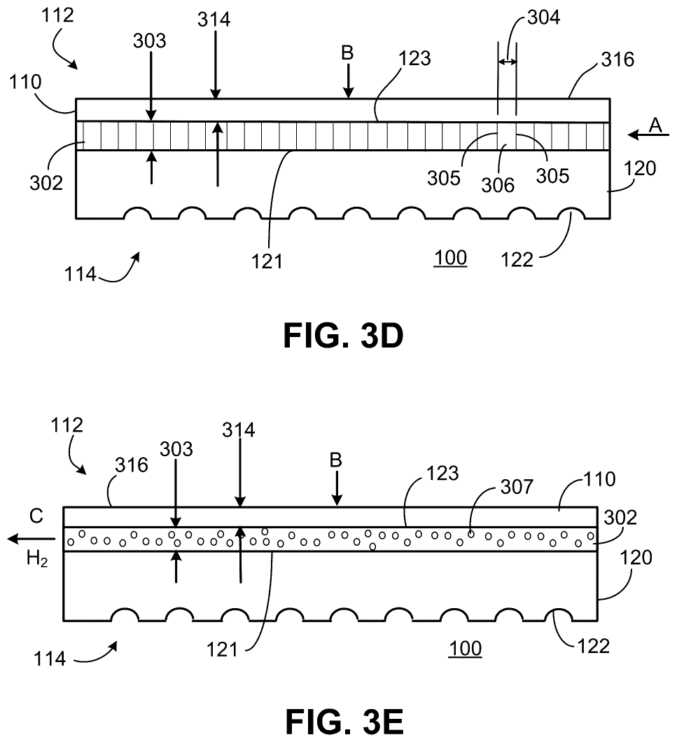

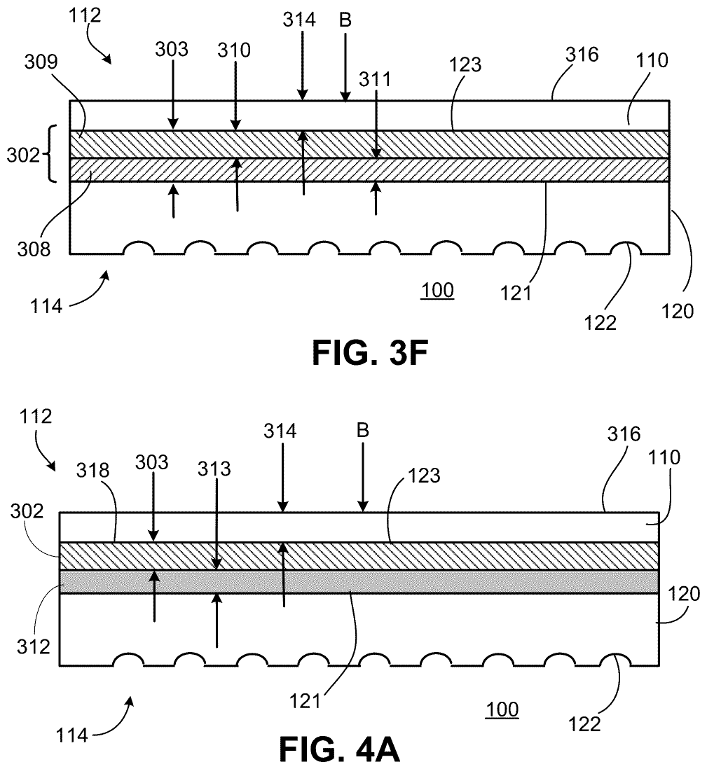

FIG. 3A is a cross-sectional view depicting an example embodiment of a neutron generation target 100. FIGS. 3B and 3C are perspective views of an upstream side 112 and a downstream side 114, respectively, of the target 100. Referring to FIG. 3A, target 100 includes a neutron generating layer 110. In a position downstream of a proton beam propagating in direction B, target 100 includes the intermediate layer 302, which is bonded to and supports the neutron generating layer 110. The intermediate layer 302, in turn, is supported by highly thermoconductive substrate 120, which, in some embodiments, contains spiral channels 122 where a coolant fluid flows to remove heat generated in the target 100 during operation. Some embodiments of the neutron generating region, the intermediate layer, and the substrate, as well as the alternative embodiments of the neutron generating targets, are described herein. Various embodiments of methods of making the targets and methods of using the targets, for example in BNCT, are also described herein.

### Examples of Embodiments of an Intermediate Layer

The intermediate layer, such as layer 302 referring to FIGS. 3A-3C, may contain any material or a combination of materials configured to achieve the desired objectives, improve properties, and extend the lifetime of the target 100. As described herein, the material of the intermediate layer 302 does not react or has minimal chemical reactivity with the material of the neutron generation layer 110, such as lithium. The material of the intermediate layer 302 can be selected such that it does not substantially diffuse into, alloy with, or form a eutectic mixture with the material of the neutron generation layer 110. Similarly, the material of the intermediate layer can be selected such that it does not excessively diffuse into or alloy with the material of the substrate 120. In addition, the material of the intermediate layer 302 preferably has a high thermal conductivity and ability to sequester, flow, or diffuse hydrogen to prevent blistering of the substrate 120. As used herein, “high thermal conductivity” refers to thermal conductivity of 300 watts per meter-kelvin (W×m⁻¹×K⁻¹) or greater (e.g., 400 W×m⁻¹×K⁻¹ or greater). The material of the intermediate layer 302 can also have a low likelihood of radioactivation under proton and neutron bombardment, promoting safety of the personnel handling replacement of the target in the system 10.

The thickness of the intermediate layer 302 is dependent on a particular application of the target, which can vary as set forth herein. For example, the thickness of the intermediate layer, measured along the axis B of the proton beam, see numeral 303 in FIG. 3A and throughout, may range from about 10 microns (μm) to about 5 millimeters (mm), from about 10 μm to about 2 mm, from about 10 μm to about 1 mm, from about 20 μm to about 1 mm, from about 50 μm to about 5 mm, from about 50 μm to about 1 mm, from about 50 μm to about 750 μm, from about 50 μm to about 500 μm, from about 50 μm to about 250 μm, or from about 50 μm to about 200 μm. In some embodiments, the thickness 303 is about 20 μm, about 50 μm, about 100 μm, about 200 μm, about 250 μm, about 400 μm, about 500 μm, about 750 μm, about 1 mm, or about 2 mm. The thickness may be selected to ensure that all protons leaving the neutron generation layer 110 are slowed to below 1 eV and do not reach substrate 120, and the total accumulation of hydrogen is below the ability of intermediate layer 302 to sequester all the hydrogen supplied to the target, and such that the thermal conductivity of the intermediate layer is sufficient to allow efficient removal of heat from the target 100 during proton bombardment. In some embodiments, the thickness of the intermediate layer may be chosen such that only a fraction of the incident protons are slowed below 1 eV and are allowed to accumulate in the substrate. In this embodiment, the total dose of protons is kept below the blistering threshold of the substrate material where accumulated protons form gaseous hydrogen within the substrate material. In some embodiments, hydrogen sequestration has a limit set by either the ability of the intermediate layer to react with the layer or to be intercalated into the layer. One example of an accepted limit for intercollation is 4.5 wt. % hydrogen in graphite. For an example of a dense piece of graphite without porous structure, this limit can correspond to at least a 45 μm thick layer of graphite per amp-hour of protons deposited over a circular area of 100 mm diameter into a graphite intermediate layer. Other materials are similarly limited in their ability to sequester hydrogen based on their individual capacities and internal reactions. Porous structured graphite with the ability to enable hydrogen to escape through channels and porosity, can accept more than 4.5 wt. % hydrogen enabled by its ability to allow hydrogen to constantly and continuously diffuse out of the material itself into the pores and be removed via vacuum pumping. Other materials are similarly enhanced by porous structures that enable capture and release of hydrogen in excess of the sequestration limit for each material. In some embodiments, the material of the intermediate layer 302 has high thermal conductivity. In some embodiments the intermediate layer may be a composite material. One component of the composite will serve to give mechanical stability and thermal conductivity and the other component can dissolve hydrogen or has high diffusion constant for hydrogen. In some embodiments, the thermal conductivity of intermediate layer 302 is about equal to or greater than thermal conductivity of the material of substrate 120. For example, thermal conductivity of intermediate layer 302 may range from 300 watts per meter-kelvin (W×m⁻¹×K⁻¹) to about 2,500 W×m⁻¹×K⁻¹. In some examples, the thermal conductivity of the intermediate layer 302 is about 400 W×m⁻¹×K⁻¹, about 500 W×m⁻¹×K⁻¹, about 750 W×m⁻¹×K⁻¹, about 1,000 W×m⁻¹×K⁻¹, about 1,500 W×m⁻¹×K⁻¹, about 1,700 W×m⁻¹×K⁻¹, about 2,000 W×m⁻¹×K⁻¹, about 2,200 W×m⁻¹×K⁻¹, or about 2,500 W×m⁻¹×K⁻¹.

In some examples, the intermediate layer 302 comprises a metal or a metal compound. Suitable examples of metals useful in the intermediate layer 302 include platinum (Pt), tantalum (Ta), titanium (Ti), aluminum (Al), tin (Sn), zirconium (Zr), Hafnium (Hf), vanadium (V), niobium (Nb), holmium (Ho), nickel (Ni), palladium (Pd), zinc (Zn), or a combination thereof. A combination of metals of the intermediate layer 302 may include magnesium-nickel alloys (e.g., Mg₂Ni), magnesium-iron alloys (e.g., Mg₂Fe), or a similar alloy. Suitable examples of metal compounds include salts, oxides, silicides, nitrides, and carbides of the aforementioned metals. In some embodiments, the intermediate layer 302 includes (e.g., is composed entirely of) a metal compound selected from tantalum nitride (TaN), titanium nitride (TiN), tantalum silicon (TaSi₂), and tantalum silicon nitride (TaSi₂N). Other nitrides are also possible, such as tungsten nitride, (WN), niobium nitride (NbN), molybdenum nitride (MoN), chromium nitride (CrN), vanadium nitride (VN), zirconium nitride (ZrN), hafnium nitride (HfN). Nitride mixtures, such as titanium tungsten nitride (TiWN), can also be used. In some embodiments, the intermediate layer 302 comprises pure aluminum (e.g., 99 wt. % or 99.5 wt. % aluminum). In some embodiments, the intermediate 302 layer comprises pure platinum (e.g., 99 wt. % or 99.5 wt. % platinum). In some embodiments, the intermediate 302 layer comprises pure titanium (e.g., 99 wt. % or 99.5 wt. % titanium). In some embodiments, the intermediate 302 layer comprises pure tin (Sn) (e.g., 99 wt. % or 99.5 wt. % tin (Sn)). In some embodiments, the intermediate 302 layer comprises pure titanium nitride (TiN) (e.g., 99 wt. % or 99.5 wt. % TiN). In some embodiments, the material of the intermediate layer comprises is an alloy of aluminum and platinum (Al/Pt). In some embodiments, the Al/Pt alloy comprises about 30 wt. %, about 50 wt. %, about 60 wt. %, about 70 wt. %, about 80 wt. %, or about 90 wt. % of aluminum. In some embodiments, the material of the intermediate layer comprises is an alloy of aluminum and titanium (Al/Ti). In some embodiments, the Al/Ti alloy comprises about 30 wt. %, about 50 wt. %, about 60 wt. %, about 70 wt. %, about 80 wt. %, or about 90 wt. % of aluminum. In some embodiments, the material of the intermediate layer comprises is an alloy of platinum and titanium (Pt/Ti). In some embodiments, the Pt/Ti alloy comprises about 30 wt. %, about 50 wt. %, about 60 wt. %, about 70 wt. %, about 80 wt. %, or about 90 wt. % of titanium. Without being bound by any particular theory or speculation, it is believed that a metal or metal compound in the intermediate layer 302 may sequester hydrogen (e.g., protons) penetrating the neutron generating layer 110 in direction B by chemically reacting with it and forming a metal hydride. In some embodiments, thermal conductivity of the intermediate layer 302 modified by the hydride reaction is no less that about 90%, about 80%, or about 75% of the thermal conductivity of intermediate layer 302 without any hydride.

In some embodiments, the intermediate layer 302 comprises a non-metal or a derivative thereof. Examples of such a material include nitrogen (N), carbon (C), germanium (Ge), silicon (Si), silicon oxides (e.g., SiO, SiO₂), silicon nitrides (e.g., Si₃N₄), carbon nitrides (e.g., C₃N₄), and other similar silicon, germanium, and carbon-based material. In some embodiments, the intermediate layer 302 comprises pure silicon (e.g., 99 wt. % or 99.5 wt. % silicon). In some embodiments, the intermediate layer 302 comprises pure germanium (e.g., 99 wt. % or 99.5 wt. % germanium). In some embodiments, the intermediate layer 302 comprises pure carbon (e.g., 99 wt. % or 99.5 wt. % carbon). In some embodiments, the intermediate layer 302 comprises pure nitrogen (e.g., 99 wt. % or 99.5 wt. % nitrogen). In some embodiments, the intermediate layer 302 comprises a nitrogen compound.

In some embodiments, the intermediate layer 302 comprises graphite. Suitable examples of graphite include highly oriented solid, non-oriented solid, fibrous graphite, carbon fiber reinforced carbon, porous graphite, carbon nanotubes, and graphene (single sheet planar graphite). In some embodiments, the graphite in the intermediate layer 302 is a highly oriented solid, carbon fiber reinforced carbon with well oriented fibers, well oriented filler graphite, bundles of well-oriented fibers, bundles of well-oriented nanotubes, and porous graphite with high thermal conductivity. In some embodiments, the intermediate layer 302 comprises pure graphite (e.g., 99 wt. % or 99.5 wt. % graphite). In some embodiments, the graphite in the intermediate layer 302 has high thermal conductivity.

In some embodiments, the intermediate layer 302 comprises oriented pyrolytic graphite. FIG. 3D is a cross-sectional view of an example embodiment of target 100 containing an intermediate layer 302 comprising an oriented pyrolytic graphite. In some embodiments, the oriented pyrolytic graphite comprises sheets or fibers of carbon that are uniformly oriented (e.g., aligned) and extend in a direction perpendicular to a planar surface of the target (e.g., parallel to the axis of the proton beam that is incident on the target 100 in direction B as shown in FIG. 3D). For example, the intermediate layer 302 can include concentric tubes of graphite material, with tubes of smaller radii being positioned nearer to a center of the target 100 and tubes with larger radii being positioned nearer to an edge of the target 100. Each tube that is between a centermost tube and an outermost tube can be substantially equidistant from an adjacent inner concentric tube and an adjacent outer concentric tube.

In some embodiments, the oriented pyrolytic graphite is highly oriented. In one example of the highly oriented pyrolytic graphite, greater than 50%, 75%, 90% or 99% of the material constituents (e.g., sheets, fibers, etc.) are substantially equidistant from one another. For example, variation of distance 304 between any two adjacent carbon sheets 305 may be about 0.1%, about 0.5%, about 1%, about 2%, about 5%, or about 10%). In this example, the constituents of the highly oriented graphite may be aligned or substantially aligned (parallel to one another), and for the plurality of substantially aligned constituents, variation in alignment may be about 0.1%, about 0.5%, about 1%, about 2%, about 5%, or about 10%. Also in this example, the plurality of aligned or substantially aligned constituents (e.g., sheets of carbon atoms) of the highly oriented graphite may be parallel or substantially parallel to direction B, which in some examples is a direction in which the proton beam is incident on the target. The substantially parallel constituents may be within about 1 degree (°), about 2°, about 5°, about 10°, about 15°, or about 30° to the direction B. In some examples, the plurality of aligned or substantially aligned constituents (e.g., sheets of carbon atoms) of the highly oriented graphite may be perpendicular or substantially perpendicular to a vector in a plane of a surface of the target 100, shown as direction Ain FIG. 3D. The substantially parallel constituents may be within about 1 degree (°), about 2°, about 5°, about 10°, about 15°, or about 30° to a perpendicular of the direction A In some embodiments, the oriented pyrolytic graphite is highly oriented.

Referring to FIG. 3D, the intermediate layer comprises carbon sheets (flat layers of carbon atoms) 305 of a single atom or nearly single atom thickness. Any two adjacent carbon sheets 305 are located at a distance (see numeral 304 in FIG. 3D) from about 0.1 nm to about 0.5 nm, and are bonded by Van der Waals forces. In one example, about 50%, about 75%, about 90%, about 95%, or about 99% of the plurality of carbon sheets 305 within the intermediate layer 302 are substantially equidistant from one another and are aligned or substantially aligned and are parallel or substantially parallel to the axis of the incoming beam in direction B. In some embodiments, the carbon sheets 305 within the intermediate layer 302 are substantially equidistant from one another (e.g., variation of distance 304 between any two adjacent carbon sheets 305 may be about 0.1%, about 0.5%, about 1%, about 2%, about 5%, or about 10%). In some embodiments, the carbon sheets 305 in the intermediate layer 302 are substantially aligned. In some embodiments, the aligned or substantially aligned sheets 305 are substantially parallel to the axis of the incoming beam in direction B.

Without being bound by any theory, it is believed that hydrogen (protons) leaving the neutron generation layer 110 is sequestered in the oriented graphite intermediate layer 302 by being intercalated in the space 306 between any two adjacent carbon sheets 305, without reacting with the graphite thereby preserving the chemical composition and thermal conductivity of the graphite layer. Without being bound by any theory or speculation, it is also believed that thermal conductivity of the intermediate layer 302 comprising highly oriented pyrolytic graphite in direction B is about 300 times, about 250 times, about 200 times, about 150 times, or about 100 times greater compared to thermal conductivity in the direction A (see FIG. 3D) that is parallel to the surface of substrate 120 and perpendicular to direction B. In some embodiments, the thermal conductivity of intermediate layer 302 in direction B is about equal to or greater than thermal conductivity of the material of substrate 120. For example, thermal conductivity of the oriented graphite layer 302 in direction B is above 300 W×m⁻¹×K⁻¹, or above 400 W×m⁻¹×K⁻¹, or above 500 W×m⁻¹×K⁻¹, or above 1300 W×m⁻¹×K⁻¹, or above 1400 W×m¹×K⁻¹, or from about 400 W×m⁻¹×K⁻¹ to about 2000 W×m⁻¹×K⁻¹. At the same time, thermal conductivity of the oriented graphite layer 302 in direction A is about 5 W×m⁻¹×K⁻¹, about 7 W×m⁻¹×K⁻¹, or about 10 W×m⁻¹×K⁻¹.

In some embodiments, the intermediate layer 302 comprises a porous graphite (e.g., porous graphite with high thermal conductivity). FIG. 3E is a cross-sectional view of an example embodiment of target 100 containing an intermediate layer 302 comprising a porous graphite. Referring to FIG. 3E, the graphite layer 302 comprises a plurality of pores 307. In some embodiments, mean, number average, or volume average pore size of the pores 307 is from about 0.1 nm to about 200 nm, from about 0.2 nm to about 150 nm, from about 1 nm to about 100 nm, from about 5 nm to about 75 nm, from about 10 nm to about 50 nm, or from about 15 nm to about 25 nm. In some embodiments, density of the porous graphite in the intermediate layer 302 is from about 1.5 gram per cubic centimeter (g/cm³) to about 3 g/cm³, about 1.75 g/cm³, about 2 g/cm³, about 2.1 g/cm³, about 2.2 g/cm³, 2.25 g/cm³, about 2.3 g/cm³, or about 2.5 g/cm³. In some embodiments, the porous graphite of the layer 302 may be or low, medium, or high porosity. As used here, the term “porosity” refers to percent ratio of void space (total volume of pores) to the total volume of the graphite material. In some embodiments, the intermediate layer comprises porous graphite material having porosity from about 0.5 percent (%) to about 40%, from about 1% to about 35%, from about 5% to about 30%, or from about 5% to about 20%. In some embodiments, porosity of the porous graphite is about 5%, about 8%, about 10%, about 12%, about 13%, about 15%, about 16%, about 18%, or about 20%. In some embodiments, the porous graphite has low, medium, or high gas permeability. In some embodiments, the average permeability of the porous graphite is from about 1×10⁻¹⁵ squared meters (m²) to about 6×10⁻¹⁴ m². In some embodiments, the average permeability of the porous graphite is from about 1×10⁻¹⁵ squared meters (m²) to about 1×10⁻¹¹ m². Without being bound by any particular theory of speculation, it is believed that the protons entering the intermediate layer 302 downstream of the neutron generation layer 110 accumulate and form hydrogen gas, which fills the pores of the porous material of the layer 302 and diffuses out of the target in directions A and C into the vacuum system. Hydrogen may also diffuse toward the lithium layer and react with a small fraction of the lithium layer on its surface, e.g., to form lithium hydride (LiH). Without being bound by theory, it is believed that the reaction with a small fraction of lithium in the neutron generation layer 110 does not substantially decrease neutron production.

In some embodiments, a combination (e.g., layering) of suitable materials may be used as an intermediate layer 302. For example, the intermediate layer 302 may include multiple layers in the form of sublayers, such as: a combination of first and second metal sublayers; a metal first sublayer with a metal compound second sublayer; a metal compound first sublayer with a metal compound second sublayer; a metal or metal compound first sublayer with a non-metal second sublayer, a non-metal or non-metal compound first sublayer with a non-metal or non-metal compound second sublayer, or others described herein. FIG. 3F is a cross-sectional view of an example embodiment of target 100 containing an intermediate layer 302 comprising a combination of materials. Referring to FIG. 3F, the intermediate layer 302 contains a first sublayer 308 adjacent to and supported by substrate 120, and a second sublayer 309 positioned between the first sublayer 308 and the neutron generation layer 110. The first sublayer 308 and the second sublayer 309 may be similar or dissimilar materials bonded to one another by covalent, ionic, metallic, electrostatic, or Van der Waals bonds and interactions. For example, the first sublayer 308 may contain a metal or a metal compound, such as platinum (Pt), titanium (Ti), tantalum (Ta), tantalum nitride (TaN), or titanium nitride (TiN), or a combination thereof, and the second sublayer 309 may contain a non-metal compound, such as silicon, germanium, or carbon, or a combination thereof. In another example, the first sublayer 308 may contain a non-metal and the second sublayer 309 may contain a metal or metal compound. Suitable examples of intermediate layer 302 containing a combination of materials include titanium and silicon sublayers, titanium and graphite sublayers, titanium and germanium sublayers, platinum and silicon sublayers, platinum and graphite sublayers, and platinum and germanium sublayers. A ratio of thickness of the first sublayer 308 (see numeral 311 in FIG. 3F) to the thickness of the second sublayer 309 (see numeral 310 in FIG. 3F) may range from about 1/100 to about 100/1 (e.g., about 1/20, about 1/10, about 1/2, about 1/1, about 2/1, about 10/1, or about 20/1).

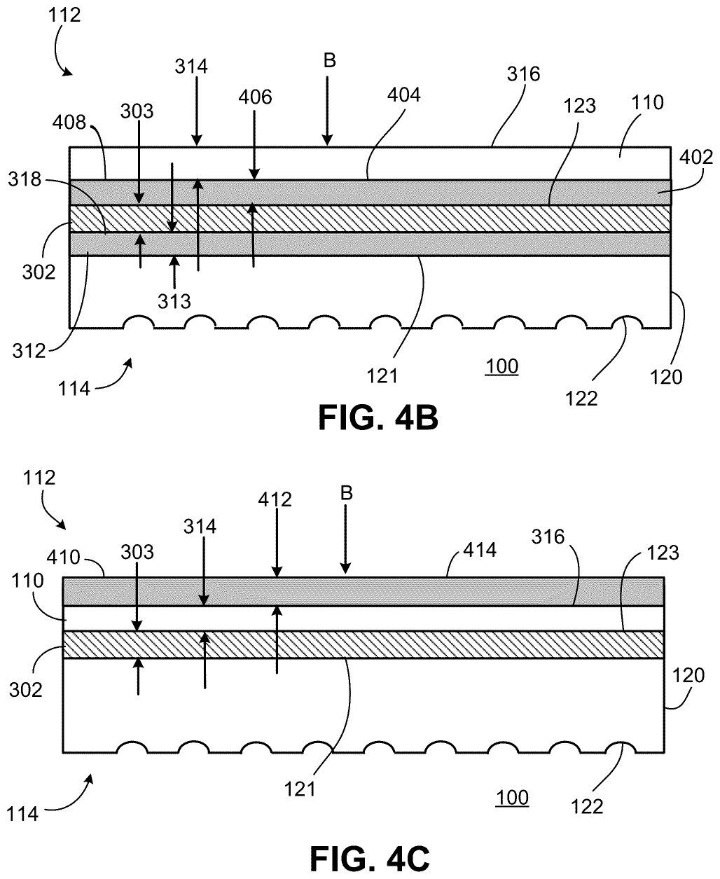

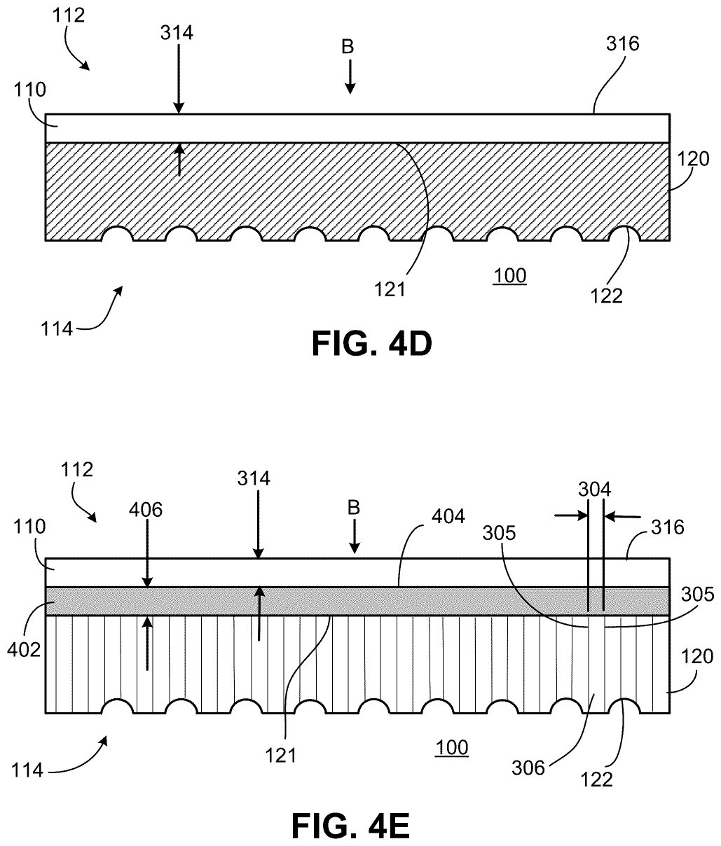

In some embodiments, the target 100 may include a layer that facilitates attachment of the intermediate layer 302 to the underlying substrate 120. FIG. 4A is a cross-sectional view of an example embodiment of target 100 containing a sub-intermediate layer 312 positioned between the substrate 120 and intermediate layer 302. For ease of description, this sub-intermediate layer 312 will be referred to herein as a brazing layer, though layer 312 can function to enable and/or facilitate attachment of layer 302 to substrate 120 through the materials and/or attributes of layer 312 as described herein without being such a brazing layer. Further, while permitted to be performed, use of the term brazing herein does not require a particular method of manufacture for the brazing layer (such as the flowing of liquid metal into a gap between the intermediate layer and substrate). Further, while permitted to be present, use of the term brazing herein does not require the presence of materials in the brazing layer (such as copper and zinc).

Without being bound by theory, it is believed that the brazing layer may be a metal or an alloy of several metals bonding the substrate with the material of the intermediate layer 302. In some examples, the brazing layer includes a mixture of copper and an added material such as indium, gallium, or magnesium. The added material can be any material that has favorable eutectic temperature alloys with copper (e.g., eutectic temperatures of approximately 1000° C. or less, 950° C. or less, 900° C. or less, 850° C. or less). In some examples, the added material is a material that has a favorable eutectic temperature alloy with copper when the alloy includes fifty atomic percent or less (e.g., thirty atomic percent or less, twenty atomic percent or less, ten atomic percent or less) of the added material relative to the amount of copper. Such an alloy can include fifty atomic percent or more (e.g., seventy atomic percent or more, eighty atomic percent or more, ninety atomic percent or more) of copper relative to the amount of added material. In some examples, the mixture includes titanium hydride in combination with copper and the added material.

Example materials included in a brazing layer can include a copper titanium alloy that can further include one or more other elements, such as a metal, including but not limited to gallium (e.g., an alloy of Cu—Ga—Ti), indium (e.g., an alloy of Cu—In—Ti), or magnesium (e.g., an alloy of Cu—Mg—Ti). In some examples, materials included in the brazing layer include a copper titanium hydride alloy that include one or more other elements, such as a metal, including but not limited to gallium (e.g., an alloy of Cu—Ga—TiH₂), indium (e.g., an alloy of Cu—In—TiH₂), or magnesium (e.g., an alloy of Cu—Mg—TiH₂).

In some embodiments, the braze alloy for forming a brazing layer 312 comprises a mixture of copper particles, silver particles, and titanium or titanium hydride particles. At a eutectic melting temperature, these materials spontaneously alloy together and form an alloy with lower melting point than any of the original materials. An example of a material for forming a brazing layer is a braze alloy TICUSIL® available from Morgan braze alloys. In some embodiments, the braze alloy for forming a brazing layer 312 comprises a suspension of fine particles and granules of an alloy for titanium (Ti), copper (Cu), and silver (Ag) in a hydrogel substance as a continuous phase.

To form a braze layer 312, substrate 120 may be prepared by cleaning or etching the surface 121 of the substrate 120 with any suitable cleaning agent or etching technique. For example, cleaning agents such as isopropanol, ethanol, methanol, acetone, or other solvents or detergents and water may be used for cleaning. Also, for example, etching may be carried out by treating the surface 121 with an acid, such as acetic acid, pyruvic acid, citric acid, oxalic acid, hydrochloric acid, nitric acid, phosphoric acid, or sulfuric acid, or by a dry etching or plasma etching technique. During dry etching, the surface 121 is cleaned by physical bombardment or a chemical reaction between the etch species (such as charged ions of argon, hydrogen, oxygen, or fluorine gas, or the free radicals of these gases produced in the plasma) and the impurities on the surface 121 of the substrate 120. Without being bound by theory, it is believed that the plasma-activated atoms, radicals, and ions act like a sandblast to break down organic and inorganic contaminants, to form water (H₂O), carbon monoxide (CO), carbon dioxide (CO₂), and other volatile products that are easily removed from the surface. To form the braze layer 312, the braze alloy may be applied to the clean surface 121. In this example, the continuous phase of the hydrogel is used for convenient and uniform application of the braze alloy to the surface 121. This is followed by contacting the braze alloy mixture applied to surface 121 with the intermediate layer 302 and heating the intermediate target 100 (containing substrate 120, intermediate layer 302 over it, and a braze alloy hydrogel in between them) to a temperature from about 800° C. to about 1,200° C. In some embodiments, the applied braze alloy mixture is heated to a temperature of about 900° C. or about 1,000° C. During the heating step, the hydrogel phase decomposes and evaporates from the surface, while the particles of titanium (Ti) or titanium hydride (TiH₄), copper (Cu), and silver (Ag) alloy melt and bond with the material of the substrate 120 and the material of the intermediate layer 302. In one example, when the substrate material is copper and the intermediate layer 302 material is graphite, titanium hydride in the braze alloy decomposes and evolves hydrogen to reduce oxides on the surfaces to be bonded, the metals of the braze alloy (e.g., titanium, silver, and/or copper) melt, diffuse into, and form metallic bonds with substrate 120, while simultaneously covalently bonding with the graphite of intermediate layer 302 by forming titanium carbide (TiC). As such, the braze layer 312 formed in this process provides a strong and mechanically robust connection between the substrate 120 and the intermediate layer 302. In another example, the braze layer 312 may be formed by soldering the substrate 120 and the intermediate layer 302 using a solder comprising an alloy of tin, lead, zinc, indium, and/or silver. In some embodiments, thickness of the brazing layer (a distance between surface 121 of the substrate and surface 318 of the brazing layer, see numeral 313 in FIG. 4A) is from about 10 nm to about 500 μm, from about 100 nm to about 250 μm, from about 200 nm to about 200 μm, from about 500 nm to about 200 μm, from about 1 μm to about 150 μm, from about 1 μm to about 10 μm, or from about 10 μm to about 100 μm.

In some examples, the neutron generation layer can extend beyond the edge of the intermediate layer to make contact with the surface of the substrate. Contacting a portion of the neutron generation layer with the substrate surface can be advantageous; for example, where the intermediate layer is electrically insulating, having an electrically conducting neutron generation layer and substrate in electrical contact can help to dissipate electrical charge that could otherwise accumulate at the neutron generation layer and/or dissipate by electrical arcing from the layer to the substrate.

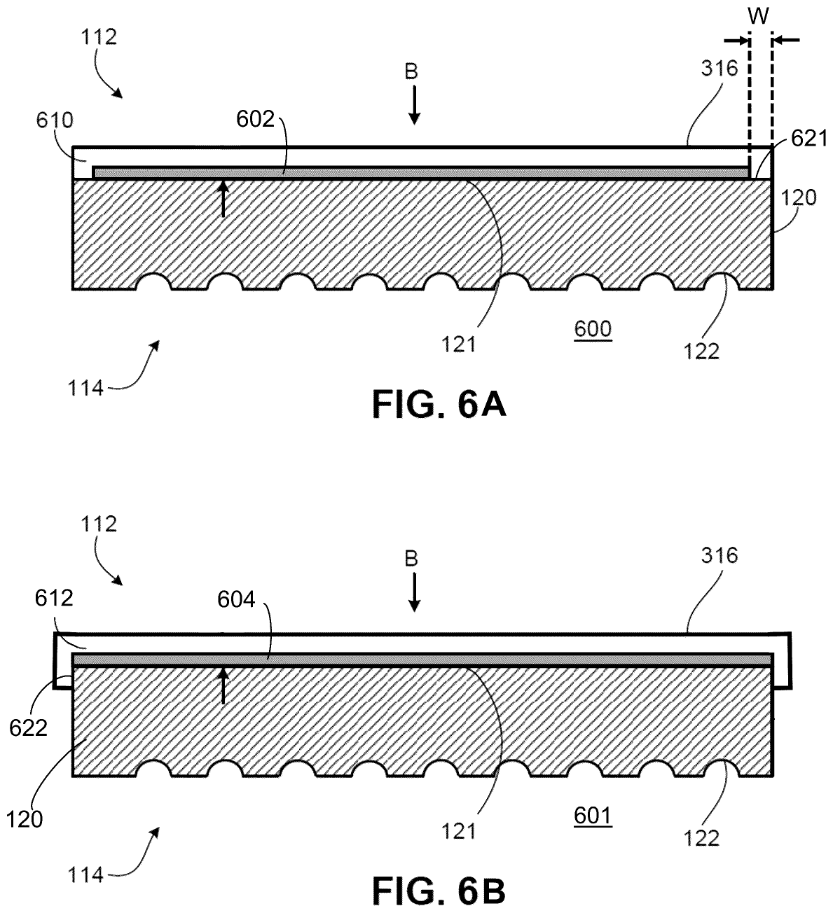

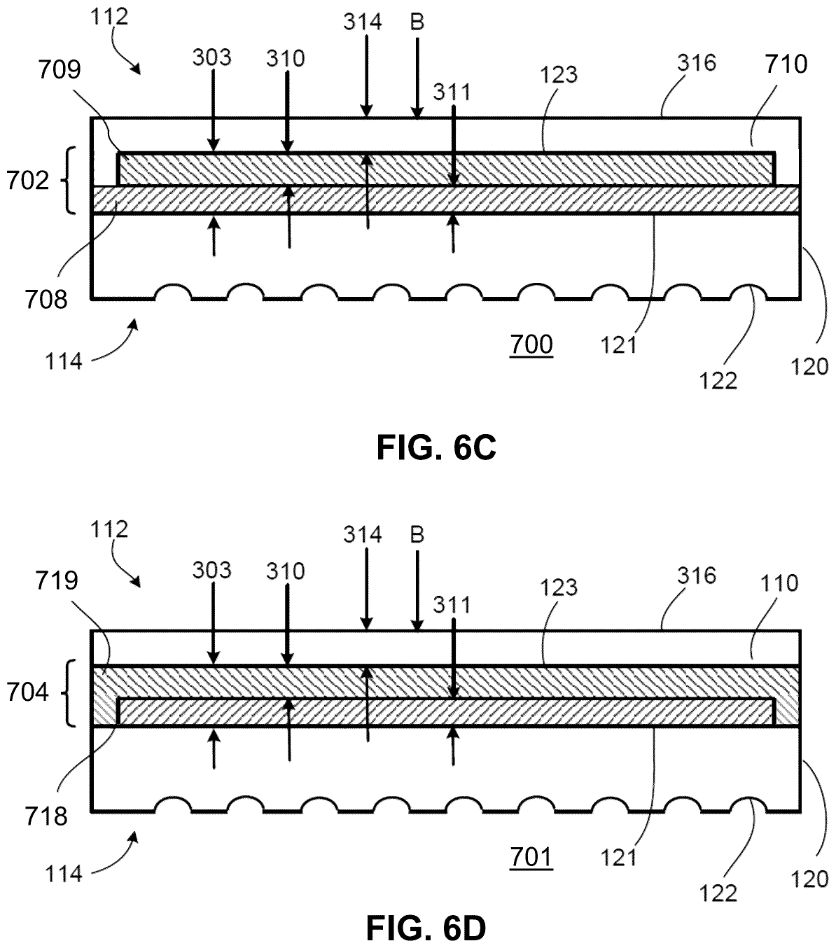

An example target configured this way is shown in FIG. 6A, which shows a target 600 that includes an intermediate layer 602 that does not extend to the edge of the surface 121 of the substrate 120, but leaves a portion 621 of this surface exposed. A neutron generation layer 610 extends beyond the edge of the intermediate layer 602 and contacts the exposed portion 621. The composition of the intermediate layer 602 and the neutron generation layer 610 can be the same as those described above, respectively.

The width, W, of the exposed portion 621—which is the distance between the edge of the intermediate layer 602 and the edge of the substrate 120—can vary. In some examples, W is 1 cm or less (e.g., 5 mm or less, 1 mm or less).

While the example shown in FIG. 6A depicts the neutron generation layer 610 extending evenly over opposite edges of the intermediate layer 602, implementations are not so limited. More generally, the neutron generation layer 610 can extend beyond the edge of the intermediate layer 602 and contact the surface 121 of the substrate 120 continuously around the entire perimeter of the intermediate layer 602, or just at one or more discrete locations.

Furthermore, in some examples, the neutron generation layer can extend down a side of the substrate 120, providing contact with the substrate material at the edge surface (e.g., alternatively to the top surface) of the substrate. An example of such a configuration is shown in FIG. 6B, in which a target 601 includes an intermediate layer 604 that extends to the edge of the surface 121. A neutron generation layer 612 extends beyond the edge of the intermediate layer 604 and down the edges of the substrate 120, contacting the edge surface 622 of the substrate 120.

Where the neutron generation layer extends beyond the edge of the intermediate layer for the purpose of charge dissipation, the amount surface contact between the neutron generation layer material and the surface of the substrate should be sufficient to provide an amount of electrical contact between the layer and the substrate to adequately dissipate charge during operation.

In examples where the intermediate layer 602 or 604 is composed of two or more sublayers, the sublayers can extend by different amounts over the top surface 121 of the substrate 120. For example, an upper sublayer can extend over only a portion of the sublayer beneath it, leaving a portion (e.g., an edge) of the lower sublayer exposed. The exposed portion of the lower sublayer can be in contact with the neutron generation layer. FIG. 6C shows an example of such a target 700 that includes an intermediate layer 702 between a neutron generation layer 710 and the substrate 720. The intermediate layer 702 is composed of a first sublayer 708 and a second sublayer 709, supported by the first sublayer. The first sublayer 708 extends over the surface 121 to the edge of the substrate 120. The second sublayer 709 extends over a central portion of the first sublayer but not to the edge of the substrate 120, leaving a portion of the surface of the first sublayer exposed to contact the neutron generation layer 710.

In examples where the material forming the first sublayer is electrically conducting, but the material forming the second sublayer is not, contact between the neutron general layer 710 and the first sublayer 708 at the edge of the target can facilitate charge dissipation from the neutron generation layer as discussed previously.

In certain examples, the first sublayer is formed from graphite and the second sublayer is formed from an electrically insulating nitride, such as TaN or the other nitrides described above.

In some examples, the first sublayer is formed from graphite and the second sublayer is formed an electrically insulating form of carbon, such as diamond or diamond-like carbon (e.g., a form of carbon with a high degree of sp3 bonding).

Referring to FIG. 6D, in another example, a target 701 includes a multilayer intermediate layer 704 between the substrate 120 and the neutron generation layer 110. The intermediate layer is composed of a first sublayer 718 which is disposed on the surface 121 of the substrate, and a second sublayer 719 disposed on top of the first sublayer. The first sublayer 718 does not extend to the edge of the substrate 120, leaving a portion of the surface 121 exposed at the edge of the target. The second sublayer 719 covers the top surface of the first sublayer and the exposed portions of surface 121.

In examples where the first sublayer 718 is composed of an electrically insulating material and the second sublayer 719 is composed of an electrically conducting material, the connection of the second sublayer to the surface of the substrate exposed at the edges can facilitate charge dissipation from the neutron generating layer 110 by providing a conducting pathway to the substrate.

In certain examples, the first sublayer is composed of a nitride material (e.g., TaN or the other nitrides described above) and the second sublayer is composed of graphite.

In some examples, the first sublayer is composed of an electrically insulating form of carbon, such as diamond or diamond-like carbon, and the second sublayer is composed of graphite.

### Examples of Embodiments of a Neutron Generation Region

FIGS. 3A-3F, 4A, and 6A-6D provide cross-sectional views of various embodiments of a target 100 containing a neutron generation layer 110 or region 610. In some embodiments, the neutron generation layer includes lithium. For example, the neutron generation layer 110 includes about 75 wt. %, about 85 wt. %, about 90 wt. %, about 95 wt. %, or about 99 wt. % of lithium. In some embodiments, the neutron generation layer 110 includes lithium compounds, including lithium oxide (Li₂O), lithium hydroxide (LiOH), lithium nitride (Li₃N), lithium carbonate (Li₂CO₃), and lithium fluoride (LiF). The lithium in this layer may be a naturally occurring lithium composed of two stable isotopes, Li⁶ and Li⁷. An amount of Li⁷ isotope in the naturally occurring lithium material may range from about 90 wt. % to about 99 wt. %, or from about 92 wt. % to about 98 wt. %. In some embodiments, the lithium in the layer 110 is enriched in Li⁷ and depleted in Li⁶, such that the lithium material contains about 99.9 wt. % or about 100 wt. % of Li⁷. The lithium in layer 110 may also contain other isotopes of lithium, such as Li³, Li⁴, Li⁸, Li¹¹, or Li¹², or any combination thereof with the Li⁶ and/or Li⁷ isotopes.

In some embodiments, the neutron generation layer 110 may be configured as a planar neutron generation layer bonded to surface 123 of an intermediate layer 302. A proton beam propagating in direction B (e.g., from tandem accelerator 16 along HEBL 18 as shown in FIG. 1A) interacts with the layer 110 to produce neutrons that, in turn, pass through intermediate layer 302 and then substrate 120 and exit from downstream side 114 of target 100. The thickness of the neutron generation layer 110 (e.g., the distance between the outer surface 123 of the intermediate layer 302 and the outer surface 316 of the neutron generation layer 110, see numeral 314 in FIGS. 3A-4A) can be selected depending on the energy of the protons propagating in the direction B. Table 1 illustrates the range (sometimes referred to as stopping range) of the average incident proton particle in naturally abundant lithium (approx. 92% lithium-7) for several proton energies. In the right column the variable “depth-to threshold” is listed, and represents the distance which an average proton travels inside of the material before it slows down to the threshold energy for a ⁷Li(p,n)⁷Be reaction (about 1.88 MeV). After a proton is slowed past this threshold energy it can no longer produce neutrons. For instance, for a proton energy of 2.50 Mega electron-volts (MeV), the highly energetic proton enters the lithium material and then travels about 90 microns in lithium until it slows to the threshold energy. In this example, if the lithium thickness is less than 90 microns (μm), the neutron yield would be decreased and the lithium material is not utilized most efficiently. It is practically desirable to have a sufficiently thick lithium layer for the neutron-producing target, but not so thick (e.g., 200 μm for the 2.5 MeV proton energy) that reduction of the proton's energy below the threshold dissipates excessive heat in the lithium or produces undesirable gamma-radiation.

TABLE 1
Lithium Range in Natural Abundance (⁷Li, about 92 wt. %)

| Proton Energy (MeV) | Range in Lithium (μm) | Depth to Threshold (μm) |
|---|---|---|
| 3.00 | 319.77 | 176.27 |
| 2.75 | 274.89 | 131.39 |
| 2.50 | 233.11 | 89.61 |
| 2.25 | 194.48 | 50.98 |
| 2.00 | 159.08 | 15.58 |
| 1.88 | 143.50 | 0.00 |
| 1.80 | 133.12 | NA |

In some embodiments, the thickness of the neutron generation layer 110 (e.g., distance from surface 123 of the intermediate layer 302 and outer surface of the neutron generation layer 110, see numeral 314 in FIGS. 3A-4B) is from about 15 μm to about 180 μm, from about 20 μm to about 150 μm, from about 40 μm to about 120 μm, from about 80 μm to about 120 μm, or from about 90 μm to about 100 μm. In some embodiments, the proton energy is from about 2 MeV to about 3 MeV, or from about 2.25 MeV to about 2.75 MeV. In some embodiments, the proton energy is about 2.5 MeV and the thickness of the lithium layer on the substrate surface is about 90 μm or about 100 μm.

In some embodiments, the neutron generation layer 110 in FIGS. 3A-4A may be added to an intermediate target 100 which already includes the substrate 120 and the intermediate layer 302. To add a neutron generation layer 110 over the intermediate layer 302, the surface 123 of the intermediate layer 302 may be cleaned by etching the surface, e.g., as described above for etching and cleaning the surface 121 of the substrate 120. In one example, when the neutron generation layer 110 comprises lithium, the lithium may be deposited on the surface 123 of the intermediate layer 302 to the desired thickness using a conventional vapor deposition technique in the vacuum chamber. In another example, lithium may be applied to the cleaned surface 123 by cold-plasma spraying, which may be carried out in a glove box or otherwise in an air-free atmosphere, such as an inert gas atmosphere (e.g., nitrogen or argon). The strike plasma spraying may be carried out at atmospheric pressure or under a vacuum. In yet another example, a thin film of a lithium foil may be applied to the clean surface 123 of the intermediate layer 302, followed by applying a mechanical force to the foil to press it into the intermediate layer 302. In case where intermediate layer 302 comprises graphite, lithium diffuses into the graphite layer, e.g., to a depth of about 1 μm to about 20 μm, thereby forming a sufficient bonding between the neutron generation layer 110 and the intermediate layer 302. The mechanical force may be applied, e.g., using a hydraulic press or a similar machinery; a skilled mechanical engineer would be able to select and implement an appropriate device. In some embodiments, the mechanical force is from about 1 megaPascal (MPa) to about 3 MPa. Suitable examples of processes of adding a neutron generation layer 110 to the intermediate layer 302 are described, e.g., in U.S. patent application No. 63/343,924, which is incorporated herein by reference in its entirety.

In some embodiments, the target 100 includes an adhesion layer 402 positioned between the intermediate layer 302 and the neutron generation layer 110. FIG. 4B is a cross-sectional view of an example embodiment of target 100 containing an adhesion layer 402. Example of the target 100 in FIG. 4B also includes optional brazing layer 312 and the substrate 120 as described herein.

Without being bound by any particular theory of speculation, it is believed that the adhesion layer 402 may be a metal or an alloy of several metals bonding the intermediate layer 302 with the neutron generation layer 110. Suitable examples of the materials of the adhesion layer include tantalum (Ta), titanium (Ti), zirconium (Zr), hafnium (Hf), vanadium (V), niobium (Nb), tantalum (Ta), holmium (Ho), nickel (Ni), palladium (Pd), platinum (Pt), zinc (Zn), silver (Ag), aluminum (Al), gold (Au), bismuth (Bi), silicon (Si), germanium (Ge), or a mixture or an alloy thereof, a carbide thereof, a silicide thereof, or a nitride thereof. Example silicides include Tungsten Silicide (WSi) (e.g., WSi₂), platinum silicide (PtSi), and Titanium Silicide (TiSi) (e.g., TiSi₂.) Examples of a mixture of metals forming an adhesion layer also include magnesium-nickel alloys (e.g., Mg₂Ni), magnesium-iron alloys (e.g., Mg₂Fe), or a similar alloy. Another example of a material of adhesion layer includes lithium fluoride (LiF), silicon dioxide (SiO₂), iron oxide (Fe₂O₃), and iron fluoride (FeF₃). In some cases, the adhesion layer includes titanium (Ti) and titanium carbide (TiC). Further examples of materials forming an adhesion layer include diamond (e.g., chemical vapor deposition (CVD) diamond, nanodiamond, polycrystalline diamond) and diamond-like carbon. Additional examples of materials forming an adhesion layer include metal nitrides with any ratio of nitrogen atoms relative to metal atoms. For example, an adhesion layer including Tantalum and Nitrogen can include compounds of TaN, Ta₂N, Ta₃N₅, Ta₄N₅, Ta₅N₆, or any combination thereof. Further example materials for the adhesion layer include any nitride compound of Titanium Nitride (TiN), Tantalum Nitride (TaN), Titanium Tungsten Nitride (TiWN), CrN, GaN, Aluminum Nitride (AlN), Indium Nitride (InN), Boron Nitride (BN) (e.g., hexagonal BN, cubic BN, amorphous BN), Silicon Nitride (SiN) (e.g., Si₃N₄), GeN (e.g., Ge₃N₄), Zinc Nitride (ZnN) (e.g., Zn₃N₂), Lithium Nitride (LiN) (e.g., LiN), Sodium Nitride (NaN) (e.g., NaN₃), Potassium Nitride (KN) (e.g., KN₃), RbN (e.g., RbN₃), Cesium Nitride (CsN) (e.g., CsN₃), Iron Nitride (FeN) (e.g., Fe2N, Fe3N4, Fe4N, Fe7N3, Fe16N2), Molybdenum Nitride (MoN), Tungsten Nitride (WN), Vanadium Nitride (VN) (e.g., V2N), Zirconium Nitride (ZrN), ScN, YN, Lanthanum Nitride (LaN), Cerium Nitride (CeN), Praseodynium Nitride (PrN), Neodymium Nitride (NdN), Samarium Nitride (SmN), Europium Nitride (EuN), Gadolinium Nitride (GdN), Terbium Nitride (TbN), Dysprosium Nitride (DyN), Holmium Niride (HoN), Erbium Nitride (ErN), Thulium Nitride (TmN), Ytterbium Nitride (YbN), Lutetium Nitride (LuN), Beryllium Nitride (BeN) (e.g., Be3N), Magnesium Nitride (MgN) (e.g., Mg₃N), Calcium Nitride (CaN) (e.g., Ca₃N), Strontium Nitride (SrN) (e.g., Sr₃N), Barium Nitride (BaN) (e.g., Ba3N), Indium Gallium Nitride (InGaN), Lithium Sodium Nitride (LiNaN), and Titanium Molybdenum Tantalum Nitride (TiMoTaN).

Without being bound by a theory, metal oxide or metal fluoride material of the adhesion layer decomposes to release free metal when contacted with lithium of the neutron generation region, which creates good adhesion between the neutron generation region and the intermediate layer 302 when the metal alloys with and diffuses into lithium. Example materials included in the adhesion layer can include Lithium Oxide (Li₂O), Lithium fluoride (LiF), Lithium Carbonate (Li2CO3), Lithium Hydroxide (LiOH), Lithium Sulfate (Li4SO4), Lithium Sulphide (Li2S), Lithium Phosphide (Li3P), Lithium Chloride (LiCl), and halide salts of Lithium (e.g., LiBr, LiI).

In some examples, the adhesion layer is deposited using plasma sputtering. Sputtering, and other fabrication processes, can cause activation of nitrogen atoms to bond to the second material and to the third material. For example, activated nitrogen atoms can bind to graphite of the intermediate layer and to lithium of the neutron generation region. The resulting structure can then have an adhesion layer that is a thin nitrogen (or nitrogen based) layer positioned between and facilitating attachment of the intermediate layer and the lithium.

When intermediate layer 302 includes graphite, a thin layer of titanium (Ti) metal can be deposited on the cleaned surface 123 of the intermediate layer 302, followed by heating to a temperature, e.g., from about 500° C. to about 1,000° C. Without being bound by any particular theory, it is believed that titanium (Ti) metal chemically reacts with the carbon atoms of the graphite material at or near the surface 123 of the intermediate layer 302 to form titanium carbide (TiC), thereby covalently bonding the adhesion layer 402 with the intermediate layer 302. In case when the neutron generation layer 110 comprises lithium, a thin lithium foil may be applied over the titanium and titanium carbide layer 402, followed by applying the mechanical force to the lithium foil as described above. In this process, titanium diffuses into and alloys with lithium, e.g., to a depth of about 10 nm to about 2 μm, thereby forming a sufficient bonding between the neutron generation layer 110 and the adhesion layer 402.

In some embodiments, thickness of the adhesion layer (a distance between surface 123 of the intermediate layer 302 and surface 408 of the adhesion layer, see, e.g., numeral 406 in FIG. 4B) is from about 10 nm to about 20 μm, from about 10 nm to about 10 μm, from about 50 nm to about 10 μm, from about 100 nm to about 1 μm, from about 100 nm to about 2 μm, from about 1 μm to about 2 μm, or from about 1 μm to about 10 μm.

In some embodiments, the target 100 includes a passivation region 410 positioned over the neutron generation layer 110. FIG. 4C is a cross-sectional view of an example embodiment of target 100 containing passivation region 410. Referring to FIG. 4C, the example of target 100 with passivation region 410 also includes neutron generation layer 110 downstream of the passivation region 410, intermediate layer 302 bonded to and supporting the neutron generation layer 110, and substrate 120 downstream of and supporting the intermediate layer 302. Examples of materials from which the passivation region 410 can be made include one or more of lithium fluoride (LiF), lithium sulfide (Li₂S), lithium carbonate (Li₂CO₃) or any other compounds which are thermodynamically stable with Li, magnesium fluoride (MgF₂), carbon (C), diamond-like carbon, (ultra)nanocrystalline diamond, or a polymer such as parylene, polypropylene, or polyethylene. Other examples may include one or more of aluminum, silver, gold, titanium, stainless steel, aluminum silicon (AlSi), molybdenum, tungsten, tungsten carbide, tantalum, platinum, or other contamination barrier material. Other materials that are known to inhibit diffusion of lithium may be used to make the passivation region 410 positioned over the neutron generation layer 110. Lithium-containing materials such as lithium nitride (Li₃N), lithium oxide (Li₂O), and lithium hydroxide (LiOH) do not exhibit substantially low lithium diffusion coefficients and are not used as materials for the passivation region 410. In some embodiments, the passivation region 410 has a coefficient of diffusion for the material of the neutron generation layer 110 (e.g., lithium) of 1×10⁻¹³ square centimeters per second (cm²/s) or less. Region 410 can also be configured to seal against the intrusion and diffusion of externally-sourced substances (e.g., substances from the ambient environment such as air, moisture, any one or combination of oxygen, nitrogen, carbon dioxide, hydrogen, or other gases, etc.) in an upstream-to-downstream direction into or through region 410. Should such substances penetrate into target 100 then those substances can potentially contaminate or react with (e.g., oxidize) the neutron generation material (e.g., lithium) in layer 110. The ambient barrier characteristic of the passivation region 410 can have a gas permeability (measured in (cubic centimeters (cc)×millimeters (mm))/(square meters (m²)×day×atmosphere (atm)) at 25 degrees C.) for oxygen, nitrogen, and carbon dioxide that is 100 or less, preferably 3.1 or less. In some example embodiments, the thickness of passivation region 410 (e.g., distance between surface 316 of the neutron generation region and surface 414 of the passivation region 410, see, e.g., numeral 412 in FIG. 4C) does not exceed three (3) microns in BNCT applications to minimize energy reduction of incoming protons, although region 410 is not limited to such. In some embodiments, thickness of the passivation region is from about 1 μm to about 10 μm, from about 10 μm to about 100 μm. Certain embodiments of the passivation materials, as well as their thickness and other characteristics, are described in U.S. Patent Application Publication No. 2023/0009459A1, titled Materials and Configurations for Protection of Objective Materials, which is incorporated herein by reference in its entirety for all purposes.

### Examples of Embodiments of the Target Substrate

Referring to FIGS. 3A-4B and 6A-6D, the substrate 120 can be configured for heat removal to dissipate the high energy level of the incident proton beam (which may be incident at direction B) and the resultant neutron beam leaving at the downstream side 114 of the target. As described above, the thickness of the lithium layer 110 is configured such that the thickness of the lithium layer enables protons to exit layer 110 relatively soon or immediately after the proton energy drops below the threshold of the Li⁷(p,n)Be⁷ reaction for neutron formation (e.g., the threshold of 1.88 MeV for the lithium-7 isotope). This avoids further energy dissipation in layer 110, which is inefficient and leads to heating of layer 110 without neutron production. Protons at about the threshold energy level penetrate to the intermediate layer 302 and dissipate their remaining energy in the highly thermoconductive intermediate layer 302 and concomitantly in the substrate 120. Substrate 120 can be made of a material having a high thermal conductivity (e.g., the material that is a good conductor of heat), or a combination of such materials. In some embodiments, thermal conductivity of the substrate 120 is above 300 W×m⁻¹×K⁻¹, above 400 W×m⁻¹×K⁻¹, or above 500 W×m⁻¹×K⁻¹, or from about 400 W×m⁻¹×K⁻¹ to about 1000 W×m⁻¹×K⁻¹. In some embodiments, the substrate material is copper (Cu). Other suitable examples of the substrate material include copper alloys, gold, silver, beryllium, beryllium oxide, any alloys of the foregoing, chemical vapor deposited (CVD) diamond, or copper-diamond powder composites. Examples of highly thermally conductive alloys for substrate 120 include tumbaga (alloy of gold and copper), sterling (alloy of copper and silver), and electrum (alloy of gold and silver). In some embodiments, the substrate 120 is made substantially from copper. For example, the substrate 120 contains about 90 weight percent (wt. %), about 95 wt. %, about 99 wt. %, or about 100 wt. % of copper. In some embodiments, the substrate 120 is made from a material containing from about 95 wt. % to about 99 wt. % of copper. In some embodiments, the highly thermally conductive substrate 120 is made substantially from a copper-diamond powder composite. In some examples, the substrate includes graphite, e.g., the substrate 120 can be made substantially from graphite.

The protons exiting the lithium layer and depositing in the intermediate layer 302 generate a significant heat load in the substrate. For example, at an energy level of 2.5 MeV, exiting protons generate a heat load from about 20 kW to about 25 kW. The substrate therefore is actively cooled by a constant coolant flow. For example, substrate 120 may contain spiral channels 122, as depicted in FIG. 3B, or any other dimensions and configurations as desired. Suitable examples of coolants include water, ethanol, methanol, ethylene glycol, propylene glycol, or any mixtures thereof. By cooling the substrate, it is ensured that the substrate temperature during proton bombardment does not exceed the melting point of lithium (e.g., from about 180° C. to about 182° C.). In some embodiments, the substrate temperature during operation does not exceed 100° C. In one embodiment, the target is a round target (e.g., circular) which is a plate with a width (e.g., diameter) from about 4 inches to about 8 inches, or about 6 inches. The thickness of the target substrate 120 may be from about 6 mm to about 12 mm, from about 8 mm to about 12 mm, or about 8 mm. In some embodiments, the substrate is about 50 times (or five orders of magnitude), about 60 times, about 70 times, about 80 times, about 90 times, or about 100 times thicker than the neutron generation layer 110 of the target 100. Generally, the substrate 120 can be of any known shape and can be made to fit in the target assembly (e.g., target assembly 200 referring to FIG. 1). Suitable examples of shapes for substrate 120 include a circle, a triangle, a rectangle, a square, a rhombus, a trapezoid, a pentagon, a hexagon, or any combination of the foregoing. In one example, the shape of the substrate 120 is the same as the shape of the target 100 of this disclosure. In this example, the substrate 120, the neutron generation layer 110, the intermediate layer 302, any of the optional layers described herein, have substantially the same shape (e.g., a circle, a square, a rectangle, a pentagon, or a hexagon). In some embodiments, the target 100 of this disclosure (including layers 120, 302, and 110) has a circular shape. The width (e.g., diameter) (measured perpendicular to the incoming beam B) of each of the components of the target (120, 302, and 110, and optional layers) in the target 100 can be same or different. For example, the width of the target 100 and any of the components 120, 302, 110, etc., may be selected from 5 centimeters (cm) or more, 7 cm or more, 10 cm or more, 15 cm or more, 20 cm or more, from about 5 cm to about 20 cm, form about 5 cm to about 15 cm, and from about 5 cm to about 10 cm. In another example, the target components, such as substrate 120, the neutron generation layer 110, the intermediate layer 302, and any of the optional layers such as brazing layer and adhesion layer, may have different shapes. In this example, substrate 120 may be a circle, layer 302 may be a circle of substantially same diameter as the substrate 120, and the neutron generation layer may have a square or rhombus shape.

In some embodiments, the substrate 120 of the target 100 of this disclosure comprises the same material or a mixture of materials as described herein for intermediate layer 302. For example, the substrate 120 may contain graphite, such as oriented pyrolytic graphite (e.g., highly oriented pyrolytic graphite). FIG. 4D is a cross-sectional view of an example embodiment of target 100 containing substrate 120 prepared from the thermoconductive (e.g., highly thermoconductive) material described herein for intermediate layer 302. Referring to FIG. 4D, the example of target 100 also includes neutron generation layer 110 upstream of substrate 120, and also bonded to and supported by the substrate 120. FIG. 4E is a cross-sectional view of an example embodiment of target 100 containing substrate 120 prepared from highly oriented pyrolytic graphite. Referring to FIG. 4E, the target 100 also includes an adhesion layer 402 positioned between the substrate 120 and the neutron generation layer 110. The adhesion layer may be any of the layers 402 discussed hereinabove with reference to FIG. 4B.

### Methods of Use

In certain examples, the present disclosure provides methods of using the lithium-containing target of this disclosure (e.g., target 100) in BNCT to treat cancer. More specifically, the target may be included in a neutron beam system, such as the system 10 shown schematically in FIGS. 1A and 1B. The target may be included in the target assembly system 200, for example, for producing a beam of neutrons from the beam of protons. In some embodiments, the disclosure provides a method of treating cancer, e.g., in a subject in need thereof. Prior to treatment, the subject may be diagnosed with cancer by a treating physician. The physician may use any diagnostic tool generally known in the medical industry to diagnose cancer, such as biopsy. Suitable examples of cancer include liver cancer (hepatocellular carcinoma, intrahepatic cholangiocarcinoma, hepatoblastoma, or hepatic adenoma), oral cancer, colon cancer, brain cancer (e.g., glioblastoma, meningioma, or medulloblastoma), head and neck cancer, lung cancer, breast cancer, gastric cancer, extensive squamous cell carcinoma, laryngeal cancer, melanoma, sarcoma, and extramammary Paget's disease. The cancer includes recurrent cancer, pediatric cancer, and metastatic cancers.

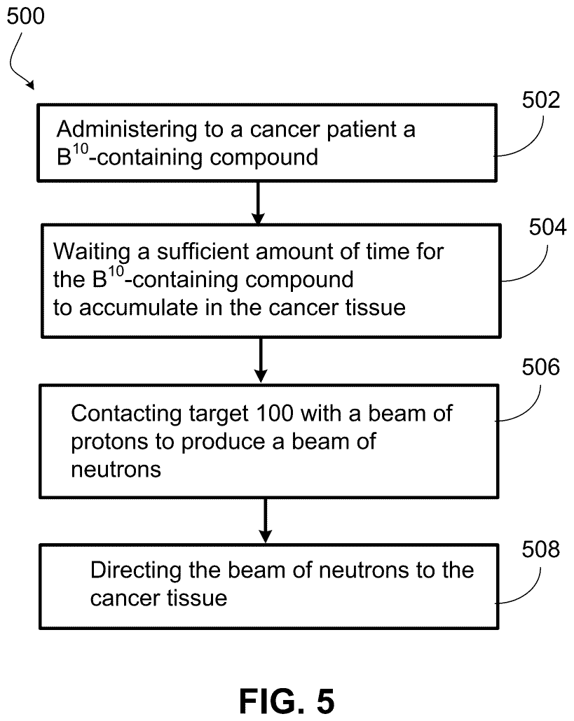

An example of a method 500 to treat cancer in a patient is provided with reference to FIG. 5. Referring to FIG. 5, the method 500 of treating cancer includes a step 502 of administering to the subject a therapeutically effective amount of a compound containing B¹⁰. Generally, the selected B¹⁰-containing compound has low systemic toxicity, rapid clearance from blood and normal tissues, high tumor uptake, and low normal tissue uptake. For example, the ratio of amount of B¹⁰ in tumor tissue to the amount of B¹⁰ in normal tissue after administration of the B¹⁰-compound is from about 2:1 to about 5:1 or from about 3:1 to about 4:1. In some embodiments, the therapeutic amount of the B¹⁰ compound is from about 1-100 mg of B¹⁰ for 1 kilogram (kg) of the subject's body weight. For example, the therapeutic amount of the B¹⁰-containing compound is from about 5 mg B¹⁰/kg to about 100 mg B¹⁰/kg, from about 5 mg B¹⁰/kg to about 80 mg B¹⁰/kg, or from about 5 mg B¹⁰/kg to about 40 mg B¹⁰/kg. The B¹⁰-containing compound can be administered to the subject in a pharmaceutical composition or a dosage form along with one or more pharmaceutically acceptable excipients. Suitable examples of such excipients include alumina, phosphate salts, colloidal silica, polyacrylates, polyethyleneglycol based polymers, and cellulose-based substances. The B¹⁰-containing compound can be administered to the subject by any suitable route of administration. For example, the compound may be administered orally, intradermally, or by intramuscular or intraperitoneal route. Examples of formulations and dosage forms for administering the B¹⁰ compound include tablets, capsules, and injectable solutions. Suitable examples of B¹⁰ compounds that can be administered to the subject include boronated derivatives of natural and unnatural amino acids, polyamines, peptides, proteins, antibodies, nucleosides, sugars, porphyrins, as well as the liposomes and nanoparticles. For example, the B¹⁰-containing compound is a boronated derivative of an amino acid such as aspartic acid, tyrosine, cysteine, methionine, or serine. In some embodiments, the B¹⁰-containing compound is boronophenylalanine, borocaptate sodium, or 1-amino-3-boronocyclo-pentanecarboxylic acid.

Referring to FIG. 5, the method 500 also includes a step 504 of waiting a sufficient amount of time for the B¹⁰-containing compound to accumulate in the cancer tissue. The amount of waiting time may range from about 10 seconds (sec) to about 2 hours (h), from about 30 sec to about 1 h, or from about 1 min to about 30 minutes (min). In one example, the B¹⁰-containing compound may accumulate in the cancer tissue at a level from about 20 to about 50 microgram (μg) of B¹⁰ per gram (g) of tumor. The sufficient accumulation of B¹⁰ in the tumor can be determined, e.g., by a treating physician by any suitable technique. In one example, the level of B¹⁰ in the tumor can be determined using biopsy and elemental analysis of the tumor tissue. In another example, the level of B¹⁰ in the tumor tissue can be determined using imaging (e.g., fluorescent imaging, PET, X-ray, CT, or MRI).

The method 500 also includes a step 506 of contacting the article of this disclosure (e.g., the neutron-generating target 100 as described above) with a beam of protons (e.g., in direction B) of appropriate energy to produce a beam of neutrons. In some embodiments, the proton energy is from about 2 MeV to about 3 MeV, from about 2.25 MeV to about 2.75 MeV, or about 2.5 MeV. The method also includes a step 508 of directing the beam of neutrons to the cancer tissue. The steps 506 and 508 can be performed as described above with reference to FIGS. 1A and 1B. In some embodiments, during the operation of the target (e.g., in step 506), it is kept at its operating temperature from about 130° C. to about 150° C. or from about 140° C. to about 150° C. For example, the target 100 may be cooled by a flow of a coolant fluid through the target in channels 122 to remove the heat. Suitable examples of the coolant fluid include water, an alcohol, and antifreeze. In one example, the coolant fluid is degassed and ultrapure water.

### Numbered Paragraphs

In some embodiments, the present invention can be described by reference to the following numbered paragraphs.

Paragraph 1. A neutron generation target, comprising:
a substrate comprising a first material;
a neutron generation region supported by the substrate and comprising a second material different from the first material, the second material being configured to generate neutrons when exposed to a charged particle beam; and
an intermediate layer supported by the substrate and positioned between the substrate and the neutron generation region, the intermediate layer comprising a third material different from the first and second materials, the third material being configured to sequester hydrogen and to facilitate heat transfer from the neutron generation region to the substrate.

Paragraph 2. The target of paragraph 1, wherein the target has a width from 5 centimeters (cm) to 20 cm.

Paragraph 3. The target of paragraph 2, wherein the width is 10 cm.

Paragraph 4. The target of any one of paragraphs 1-3, wherein thermal conductivity of the first material is from 300 watts per meter-kelvin (W×m⁻¹×K⁻¹) to 1000 W×m⁻¹×K⁻¹.

Paragraph 5. The target of any one of paragraphs 1-4, wherein the first material is selected from copper, gold, diamond-like carbon, diamond, and copper-diamond composites.

Paragraph 6. The target of any one of paragraphs 1-4, wherein the first material is copper.

Paragraph 7. The target of any one of paragraphs 1-6, wherein a thickness of the substrate is from 5 millimeters (mm) to 12 mm.

Paragraph 8. The target of paragraph 7, wherein the thickness of the substrate is selected from 5 mm, 8 mm, and 10 mm.

Paragraph 9. The target of any one of paragraphs 1-8, wherein the substrate is 2 or more times, 5 or more times, 10 or more times, 20 or more times, 50 or more times, 60 or more times, 70 or more times, 80 or more times, 90 or more times, or 100 or more times thicker than the neutron generation region.

Paragraph 10. The target of any one of paragraphs 1-9, wherein the second material comprises lithium (Li).

Paragraph 11. The target of paragraph 10, wherein lithium in the neutron generation region comprises from 92 percent by weight (wt. %) to 98 wt. % of Li⁷ isotope.

Paragraph 12. The target of any one of paragraphs 1-11, wherein a thickness of the neutron generation region is from 15 micrometers (μm) to 180 μm.

Paragraph 13. The target of paragraph 12, wherein the thickness of the second layer is from 90 μm to 100 μm.

Paragraph 14. The target of any one of paragraphs 1-13, wherein thermal conductivity of the third material is equal to or greater than the thermal conductivity of the first material.

Paragraph 15. The target of paragraph 14, wherein thermal conductivity of the third material is from 400 W×m⁻¹×K⁻¹ to 2,500 W×m⁻¹×K⁻¹.

Paragraph 16. The target of paragraph 15, wherein thermal conductivity of the third material is selected from 1,000 W×m⁻¹×K⁻¹, 1,500 W×m⁻¹×K⁻¹, 1,700 W×m⁻¹×K⁻¹, and 2,000 W×m⁻¹×K⁻¹.

Paragraph 17. The target of any one of paragraphs 1-16, wherein a thickness of the intermediate layer is from 10 μm to 1 mm.

Paragraph 18. The target of any one of paragraphs 1-17, wherein the third material comprises carbon, germanium, silicon, a silicon oxide compound, a silicon nitride compound, a carbon nitride compound, or any combination thereof.

Paragraph 19. The target of any one of paragraphs 1-18, wherein the third material comprises graphite.

Paragraph 20. The target of paragraph 19, wherein the graphite is selected from oriented solid graphite, non-oriented solid graphite, fibrous graphite, carbon fiber reinforced graphite, porous graphite, carbon nanotube-based graphite, and graphene.

Paragraph 21. The target of paragraph 20, wherein the third material comprises 99 wt. % or 99.5 wt. % of oriented pyrolytic graphite.

Paragraph 22. The target of paragraph 20, wherein the third material comprises 99 wt. % or 99.5 wt. % of porous graphite.

Paragraph 23. The target of any one of paragraphs 1-17, wherein the third material comprises platinum, tantalum, titanium, aluminum, tin, zirconium, hafnium, vanadium, niobium, holmium, nickel, palladium, zinc, magnesium-nickel alloys, magnesium-iron alloys, or a salt, an oxide, a silicide, a nitride, or carbide thereof, or a combination thereof.

Paragraph 24. The target of paragraph 23, wherein the third material comprises 99 wt. % or 99.5 wt. % of platinum.

Paragraph 25. The target of any one of paragraphs 1-24, wherein the target comprises a brazing layer positioned between the substrate and the intermediate layer and configured to facilitate bonding of the substrate to the intermediate layer through metallic bonds, covalent bonds, electrostatic interactions, intermaterial diffusion, or any combination thereof.

Paragraph 26. The target of paragraph 25, wherein the brazing layer comprises an alloy comprising titanium, copper, and silver.

Paragraph 27. The target of paragraph 25, wherein a thickness of the brazing layer is from 1 μm to 10 μm.

Paragraph 28. The target of any one of paragraphs 1-27, wherein the target comprises an adhesion layer positioned between the intermediate layer and the neutron generation region and configured to facilitate bonding of the intermediate layer to the neutron generation region through metallic bonds, covalent bonds, electrostatic interactions, intermaterial diffusion, or any combination thereof.

Paragraph 29. The target of paragraph 28, wherein the adhesion layer comprises titanium, zirconium, hafnium, vanadium, niobium, tantalum, holmium, nickel, palladium, platinum, zinc, silver, aluminum, gold, bismuth, or a mixture or an alloy thereof, or a carbide thereof.

Paragraph 30. The target of paragraph 28, wherein the adhesion layer comprises 90 wt. % or 95 wt. % of titanium.

Paragraph 31. The target of paragraph 28, wherein a thickness of the adhesion layer is from 100 nanometers (nm) to 2 μm.

Paragraph 32. The target of any one of paragraphs 1-31, wherein the target comprises a passivation region supported by the substrate and positioned over the neutron generation region and configured to seal against diffusion of the third material into the passivation region and against diffusion of an ambient substance into the passivation region.

Paragraph 33. The target of paragraph 32, wherein the passivation region comprises lithium fluoride, lithium sulfide, lithium carbonate, magnesium fluoride, carbon, diamond-like carbon, (ultra)nanocrystalline diamond, or a polymer.

Paragraph 34. The target of paragraph 32, wherein a thickness of the passivation region is from 1 μm to 10 μm.

Paragraph 35. The target of paragraph 32, wherein the passivation region has coefficient of diffusion for second material of 1×10⁻¹³ square centimeters per second (cm²/s) or less.

Paragraph 36. The target of paragraph 33, wherein the passivation region has gas permeability of 100 (cm³×mm)/(m²×day×atm) or less.

Paragraph 37. A neutron generation target, comprising:
a substrate comprising a non-porous graphite; and
a neutron generation region supported by the substrate and comprising a material configured to generate neutrons upon exposure to a charged particle beam.

Paragraph 38. The target of paragraph 37, wherein the non-porous graphite is selected from oriented solid graphite, non-oriented solid graphite, fibrous graphite, carbon fiber reinforced graphite, carbon nanotube-based graphite, and graphene.

Paragraph 39. The target of paragraph 37, wherein the substrate comprises 99 percent by weight (wt. %) or 99.5 wt. % of oriented pyrolytic graphite.

Paragraph 40. The target of any one of paragraphs 37-39, wherein the target has a width from 5 centimeters (cm) to 20 cm.

Paragraph 41. The target of paragraph 40, wherein the width is 10 cm.

Paragraph 42. The target of any one of paragraphs 37-41, wherein a thickness of the substrate is from 5 millimeters (mm) to 12 mm.

Paragraph 43. The target of paragraph 42, wherein the thickness of the substrate is selected from 5 mm, 8 mm, and 10 mm.

Paragraph 44. The target of any one of paragraphs 37-43, wherein the substrate is 2 or more times, 5 or more times, 10 or more times, 20 or more times, 50 or more times, 60 or more times, 70 or more times, 80 or more times, 90 or more times, or 100 or more times thicker than the neutron generation region.

Paragraph 45. The target of any one of paragraphs 37-44, wherein thermal conductivity of the non-porous graphite is from 400 per meter-kelvin (W×m⁻¹×K⁻¹) to 2,500 W×m⁻¹×K⁻¹.

Paragraph 46. The target of paragraph 45, wherein thermal conductivity of the non-porous graphite is selected from 1,000 W×m⁻¹×K⁻¹, 1,500 W×m⁻¹×K⁻¹, 1,700 W×m⁻¹×K⁻¹, and 2,000 W×m¹×K⁻¹.

Paragraph 47. The target of any one of paragraphs 37-46, wherein the material of the neutron generation region comprises lithium (Li).

Paragraph 48. The target of paragraph 47, wherein lithium in the neutron generation region comprises from 92 wt. % to 98 wt. % of Li⁷ isotope.

Paragraph 49. The target of any one of paragraphs 37-48, wherein a thickness of the neutron generation region is from 15 micrometers (μm) to 180 μm.

Paragraph 50. The target of paragraph 49, wherein the thickness of the neutron generation region is from 90 μm to 100 μm.

Paragraph 51. The target of any one of paragraphs 37-50, wherein the target comprises an adhesion layer positioned between the substrate and the neutron generation region and configured to facilitate bonding of the substrate to the neutron generation region through metallic bonds, covalent bonds, electrostatic interactions, intermaterial diffusion, or any combination thereof.

Paragraph 52. The target of paragraph 51, wherein the adhesion layer comprises titanium, zirconium, hafnium, vanadium, niobium, tantalum, holmium, nickel, palladium, platinum, zinc, silver, aluminum, gold, bismuth, or a mixture or an alloy thereof, or a carbide thereof.

Paragraph 53. The target of paragraph 51, wherein the adhesion layer comprises 90 wt. % or 95 wt. % of titanium.

Paragraph 54. The target of paragraph 51, wherein a thickness of the adhesion layer is from 100 nanometers (nm) to 2 μm.

Paragraph 55. The target of any one of paragraphs 37-54, wherein the target comprises a passivation region supported by the substrate and positioned over the neutron generation region and configured to seal against diffusion of the third material into the passivation region and against diffusion of an ambient substance into the passivation region.

Paragraph 56. The target of paragraph 55, wherein the passivation region comprises lithium fluoride, lithium sulfide, lithium carbonate, magnesium fluoride, carbon, diamond-like carbon, (ultra)nanocrystalline diamond, or a polymer.

Paragraph 57. The target of paragraph 55, wherein a thickness of the passivation region is from 1 μm to 10 μm.

Paragraph 58. The target of paragraph 55, wherein the passivation region has coefficient of diffusion for second material of 1×10⁻¹³ square centimeters per second (cm²/s) or less.

Paragraph 59. The target of paragraph 55, wherein the passivation region has gas permeability of 100 (cm³×mm)/(m²×day×atm) or less.

Paragraph 60. A neutron beam system, comprising:
a charged particle accelerator;
a beamline extending from the charged particle accelerator to a neutron generation target configured in accordance with any one of paragraphs 1-59.

Paragraph 61. A method of treating cancer in a subject in need thereof, the method comprising:
(i) administering to the subject a therapeutically effective amount of a compound comprising B¹⁰,
(ii) waiting a sufficient amount of time for the compound comprising B¹⁰ to accumulate in a cancer tissue within the subject,
(iii) contacting a neutron generation target of any one of paragraphs 1-59 with a beam of protons to produce a beam of neutrons, and
(iv) directing the beam of neutrons to the cancer tissue.

Paragraph 62. The method of paragraph 61, wherein the cancer is selected from liver cancer, oral cancer, colon cancer, brain cancer, head and neck cancer, lung cancer, breast cancer, gastric cancer, extensive squamous cell carcinoma, laryngeal cancer, melanoma, sarcoma, and extramammary Paget's disease.

Paragraph 63. The method of paragraph 61, wherein the therapeutic amount is from 1 milligram (mg) to 100 mg of B¹⁰ per one kilogram (kg) of the subject's body weight.

Paragraph 64. The method of paragraph 63, wherein the compound comprising B¹⁰ accumulates in the cancer tissue at a level from 20 to 50 microgram (μg) of B¹⁰ per gram (g) of tumor.

Paragraph 65. The method of any one of paragraphs 61-64, wherein the sufficient amount of time is from 30 seconds to 1 hour.

Paragraph 66. The method of any one of paragraphs 61-65, wherein energy of the beam of protons is from 2 Mega electron-volts (MeV) to 3 MeV.

Paragraph 67. The method of any one of paragraphs 61-66, comprising cooling the target during the contacting of step (iii) to maintain its operating temperature from 130 degrees Celsius (° C.) to 150° C.

Paragraph 68. The method of paragraph 67, wherein the cooling comprises contacting the target with a coolant fluid thereby removing heat from the substrate.

Paragraph 69. The method of paragraph 68, wherein the coolant fluid is selected from water, an alcohol, an antifreeze, or a combination thereof.

Paragraph 70. The target of paragraph 23, wherein the third material is TaN, TiN, WN, NbN, MoN, CrN, VN, ZrN, HfN, or a combination of thereof.

Paragraph 71. The target of paragraph 23, wherein the third material is an electrically insulating material.

Paragraph 72. The target of any one of paragraphs 1-23, 70 or 71, wherein the second material extends from the neutron generation region beyond an edge of the intermediate layer to contact a surface of the substrate.

Paragraph 73. The target of paragraph 72, wherein the second material contacts the surface of the substrate on the same surface supporting the intermediate layer.

Paragraph 74. The target of paragraph 82, wherein the second material contacts the surface of the substrate on a side surface of the substrate different from the surface supporting the intermediate layer.

Paragraph 75. The target of any one of paragraphs 1-23, 70, and 71, wherein the intermediate layer comprises at least a first sublayer that does not extend to an edge of the substrate.

Paragraph 76. The target of paragraph 75, wherein the intermediate layer comprises at least a second sublayer that does extend to an edge of the substrate.

Paragraph 77. The target of paragraph 76, wherein the second sublayer is between the substrate and the first sublayer, a portion of a surface of the second sublayer being exposed at an edge of the first sublayer.

Paragraph 78. The target of paragraph 77, wherein the second material contacts the exposed portion of the surface of the second sublayer.

Paragraph 79. The target of paragraph 78, wherein the second material is lithium, the first sublayer is composed of a nitride, and the second sublayer is composed of graphite.

Paragraph 80. The target of paragraph 76, wherein the first sublayer is between the substrate and the second sublayer, and the second sublayer contacts a portion of the surface of the substrate exposed at an edge of the first sublayer.

Paragraph 81. A neutron generation target, including:
a substrate including of a first material;
a neutron generation region supported by the substrate and including a second material different from the first material, the second material being configured to generate neutrons when exposed to a charged particle beam and being an electrically conducting material; and
an intermediate layer supported by the substrate and positioned between the substrate and the neutron generation region, the intermediate layer including a third material different from the first and second materials, the third material being an electrically insulating material,
wherein the second material extends from the neutron generation region beyond an edge of the third material.

Paragraph 82. The target of paragraph 81, wherein the first material is a metal.

Paragraph 83. The target of paragraph 81 or paragraph 82, wherein the second material is lithium.

Paragraph 84. The target of any one of paragraphs 81-83, wherein the third material is TaN, TiN, WN, NbN, MoN, CrN, VN, ZrN, HfN, or a combination of thereof.

Paragraph 85. The target of any one of paragraphs 81-84, wherein the second material extends from the neutron generation region beyond an edge of the intermediate layer to contact a surface of the substrate.

Paragraph 86. The target of paragraph 85, wherein the second material contacts the surface of the substrate on the same surface supporting the intermediate layer.

Paragraph 87. The target of paragraph 85, wherein the second material contacts the surface of the substrate on a side surface of the substrate different from the surface supporting the intermediate layer.

Paragraph 88. The target of any one of paragraphs 81-84, wherein the intermediate layer includes at least a first sublayer that does not extend to an edge of the substrate.

Paragraph 89. The target of paragraph 88, wherein the first sublayer is composed of the third material.

Paragraph 90. The target of paragraph 88 or paragraph 89, wherein the intermediate layer includes at least a second sublayer that does extend to an edge of the substrate.

Paragraph 91. The target of paragraph 90, wherein the second sublayer is between the substrate and the first sublayer, a portion of a surface of the second sublayer being exposed at an edge of the first sublayer.

Paragraph 92. The target of paragraph 91, wherein the second material contacts the exposed portion of the surface of the second sublayer.

Paragraph 93. The target of paragraph 92, wherein the second material is lithium, the first sublayer is composed of a nitride, and the second sublayer is composed of graphite.

Paragraph 94. The target of paragraph 89, wherein the first sublayer is between the substrate and the second sublayer, and the second sublayer contacts a portion of the surface of the substrate exposed at an edge of the first sublayer.

Paragraph 95. A neutron generation target, including: a substrate including a volume of copper or graphite, the volume including a flat surface and one or more channels; a neutron generation layer supported by the flat surface of the substrate and composed of lithium; and one or more intermediate layers supported by the flat surface of the substrate between the substrate and the neutron generation layer, the one or more intermediate layers including a layer of a nitride material.

Paragraph 96. The neutron generation target of paragraph 95, wherein the nitride material is TiN or TaN.

Paragraph 97. The neutron generation target of paragraph 95 or paragraph 96, wherein the layer of nitride material is the only intermediate layer between the substrate and the neutron generation layer.

Paragraph 98. The neutron generation target of paragraph 97, wherein the substrate is composed of graphite.

Paragraph 99. The neutron generation target of paragraph 95 or paragraph 96, wherein the substrate is composed of copper.

Paragraph 100. The neutron generation target of paragraph 99, wherein the one or more intermediate layers includes a graphite layer between the layer of nitride material and the substrate.

Paragraph 101. The neutron generation target of paragraph 100, wherein the one or more intermediate layers includes a brazing layer between the substrate and the graphite layer.

Paragraph 102. The neutron generation target of any one of paragraphs 95 to 101, including a lithium protection layer arranged on an opposite side of the neutron generation layer from the substrate.

Paragraph 103. The neutron generation target of paragraph 102, wherein the lithium protection layer is composed of LiF.

Paragraph 104. The neutron generation target of paragraph 101, wherein the brazing layer comprises a copper titanium alloy.

Paragraph 105. The neutron generation target of paragraph 104, wherein the copper titanium alloy includes a metal element comprising gallium, indium, or magnesium.

Paragraph 106. The target of paragraph 52, wherein the adhesion layer comprises a metal nitride, a metal silicide, a metal carbide, or a metal alloy.

Paragraph 107. The target of paragraph 52, wherein the adhesion layer comprises a titanium nitride, a tantalum nitride, or a titanium tungsten nitride.

Paragraph 108. The neutron generation target of paragraph 101, wherein the sub-intermediate layer is a brazing layer.

Paragraph 109. The neutron generation target of paragraph 95, wherein the layer comprising nitrogen consists essentially of nitrogen.

Paragraph 110. The neutron generation target of paragraph 96, wherein the nitride material is tantalum nitride or titanium nitride.

### OTHER EMBODIMENTS

It is to be understood that while the present application has been described in conjunction with the detailed description thereof, the foregoing description is intended to illustrate and not limit the scope of the present application, which is defined by the scope of the appended claims. Other aspects, advantages, and modifications are within the scope of the following claims.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

1. A neutron generation target, comprising:
a substrate comprising a first material;
a neutron generation region supported by the substrate and comprising a second material different from the first material, the second material being configured to generate neutrons when exposed to a charged particle beam; and
an intermediate layer supported by the substrate and positioned between the substrate and the neutron generation region, the intermediate layer comprising a third material different from the first and second materials, the third material being configured to sequester hydrogen and to facilitate heat transfer from the neutron generation region to the substrate.

2. The target of claim 1, wherein the target has a width from 5 centimeters (cm) to 20 cm.

3. The target of claim 2, wherein the width is 10 cm.

4. The target of claim 1, wherein thermal conductivity of the first material is from 300 watts per meter-kelvin (W×m⁻¹×K⁻¹) to 1000 W×m⁻¹×K⁻¹.

5. The target of claim 1, wherein the first material is selected from copper, gold, diamond-like carbon, diamond, and copper-diamond composites.

6. The target of claim 1, wherein the first material is copper.

7. The target of claim 1, wherein a thickness of the substrate is from 5 millimeters (mm) to 12 mm.

8-24. (canceled)

25. The target of claim 1, wherein the target comprises a sub-intermediate layer positioned between the substrate and the intermediate layer and configured to facilitate bonding of the substrate to the intermediate layer through metallic bonds, covalent bonds, electrostatic interactions, intermaterial diffusion, or any combination thereof.

26. The target of claim 25, wherein the sub-intermediate layer comprises an alloy comprising titanium, copper, and silver.

27. The target of claim 25, wherein a thickness of the sub-intermediate layer is from 1 μm to 10 μm.

28. The target of claim 1, wherein the target comprises an adhesion layer positioned between the intermediate layer and the neutron generation region and configured to facilitate bonding of the intermediate layer to the neutron generation region through metallic bonds, covalent bonds, electrostatic interactions, intermaterial diffusion, or any combination thereof.

29. The target of claim 28, wherein the adhesion layer comprises titanium, zirconium, hafnium, vanadium, niobium, tantalum, holmium, nickel, palladium, platinum, zinc, silver, aluminum, gold, bismuth, or a mixture or an alloy thereof, or a carbide thereof.

30. The target of claim 28, wherein the adhesion layer comprises 90 wt. % or 95 wt. % of titanium.

31. The target of claim 28, wherein a thickness of the adhesion layer is from 100 nanometers (nm) to 2 μm.

32. The target of claim 1, wherein the target comprises a passivation region supported by the substrate and positioned over the neutron generation region and configured to seal against diffusion of the third material into the passivation region and against diffusion of an ambient substance into the passivation region.

33. The target of claim 32, wherein the passivation region comprises lithium fluoride, lithium sulfide, lithium carbonate, magnesium fluoride, carbon, diamond-like carbon, (ultra)nanocrystalline diamond, or a polymer.

34. The target of claim 32, wherein a thickness of the passivation region is from 1 μm to 10 μm.

35. The target of claim 32, wherein the passivation region has coefficient of diffusion for second material of 1×10⁻¹³ square centimeters per second (cm²/s) or less.

36. The target of claim 33, wherein the passivation region has gas permeability of 100 (cm³×mm)/(m²×day×atm) or less.

37-110. (canceled)
